(19) United States
(12) Patent Application Publication
(10) Pub. No.: US 2020/0334697 A1
(43) Pub. Date: Oct. 22, 2020

(54) GENERATING SURVEY RESPONSES FROM UNSOLICITED MESSAGES

(71) Applicant: Qualtrics, LLC, Provo, UT (US)

(72) Inventors: Ali BaderEddin, Kenmore, WA (US); Martin D. Mumford, Provo, UT (US)

(21) Appl. No.: 16/385,335

(22) Filed: Apr. 16, 2019

(51) Int. Cl. G06Q 30/02; H04L 12/58; G06F 17/27; G06F 16/9535; G06F 16/9536; G06N 20/00; G06F 17/18

(52) U.S. Cl. CPC G06Q 30/0203; H04L 51/046; G06F 17/2705; G06F 17/2765; G06F 16/9536; G06N 20/00; G06F 17/18; G06F 16/9535

(57) ABSTRACT

The present disclosure relates to generating responses for survey questions using user-generated text blocks (i.e., segments of text extracted from messages, such as email messages, that were not composed as direct responses to the survey questions). For example, in one or more embodiments, a system analyzes a user-generated text block to determine text block characteristics (e.g., keywords used, text block length, etc.). The system then determines whether the text block characteristics relate to one or more survey questions of an electronic survey. For example, in some embodiments, the system determines relatedness if the text block characteristics satisfy a question profile associated with a survey question. If a related survey question is identified, the system can generate a response for the survey question based on the content of the user-generated text block.

### BACKGROUND

Recent years have seen an increase in the use of electronic surveys distributed to individuals, groups, or other types of respondents. For example, it is common for an entity (e.g., individual, business or other organization, etc.) to distribute electronic surveys via email using a mailing list. Indeed, electronic survey systems provide a fast, low-cost alternative to administering surveys using traditional means (e.g., traditional mail, in-person questionnaire, etc.). Further, because responses to electronic surveys are typically received in electronic form, electronic survey systems improve the entity's ability to collect, organize, store, and analyze survey results.

Despite these various benefits, however, conventional electronic survey systems have several technological shortcomings that decrease the accuracy, efficiency, and flexibility of the conventional systems. For example, conventional electronic survey systems are typically inaccurate in that they do not produce results that accurately reflect the feedback from a desired group (e.g., consumers who purchased a product or service). Specifically, conventional electronic survey systems may produce skewed results that reflect only the feedback of those members of the group who are willing to participate in the survey (i.e., the respondents). To illustrate, a conventional electronic survey system distributing an electronic survey to consumers who have purchased a particular product may only receive feedback (or a majority of the feedback) from consumers who have a habit of completing surveys or consumers who have a strong enough opinion about the product (e.g., really liked or really disliked the product) to motivate a response to the survey. By failing to account for the feedback of those who don't respond to the survey, the conventional electronic survey system fails to accurately capture results that reflect the feedback of everyone that bought the product or an accurate cross-section of people that bought the product.

Similarly, conventional electronic survey systems may provide results that only reflect feedback from a single data source (i.e., responses to the electronic survey). Accordingly, conventional systems typically fail to provide results that accurately reflect feedback provided on other data sources (e.g., a webpage, an email, etc.). To continue the example above, the conventional electronic survey system may provide results that reflect only the feedback about the product received in direct response to the electronic survey but not feedback about the same product provided by a consumer on the manufacturer's web site.

In addition to accuracy concerns, conventional electronic survey systems are also inflexible. For example, as mentioned above, conventional systems typically only gather feedback provided in response to electronic surveys, neglecting feedback available from other data sources. Consequently, to receive feedback from a desired group, conventional systems typically must distribute survey questions to each member of the group (including those who don't respond) and wait for a response before compiling the results. When considering the size of some desired groups, this may require a substantial amount of computing resources. When considering the number of survey recipients that may choose not to respond, the conventional systems can waste much of those resources.

Further, conventional electronic survey systems are inefficient based on inflexibilities. For example, conventional systems typically require respondents to answer the electronic survey within the formatting parameters established by the system (e.g., may require a respondent to answer a multiple choice question by checking the box next to the respondent's desired answer). Consequently, the conventional systems may reject responses that are provided using incompatible formats (e.g., the respondent attempts to type an answer where a choice selection is required), failing to capture potentially valuable information in the results. In short, the data structures of conventional electronic survey systems do not allow for the addition of data that can be gathered from sources other than typical responses to survey questions.

### SUMMARY

One or more embodiments described herein provide benefits and/or solve one or more of the foregoing or other problems in the art with systems, methods, and non-transitory computer readable storage media that improve computing systems by generating responses for survey questions using user-generated text blocks (i.e., segments of text extracted from messages, such as email messages, that were not composed as direct responses to the survey questions). For example, in one or more embodiments, a system analyzes a user-generated text block to determine text block characteristics (e.g., keywords used, text block length, etc.). The system then determines whether the text block characteristics relate to one or more survey questions of an electronic survey. For example, in some embodiments, the system determines that the text block characteristics relate to the survey question if the text block characteristics satisfy text characteristics (i.e., rules) associated with the survey question. If a related survey question is identified, the system can generate a response for the survey question based on the content of the user-generated text block.

The following description sets forth additional features and advantages of one or more embodiments of the disclosed systems, computer readable storage media, and methods. In some cases, such features and advantages will be obvious to a skilled artisan from the description or may be learned by the practice of the disclosed embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an unsolicited response system can operate in accordance with one or more embodiments;

FIG. 2 illustrates a block diagram illustrating an overview of generating a survey response for a survey question using a user-generated text block in accordance with one or more embodiments;

FIGS. 3A-3C illustrate example survey question profiles that include text characteristics associated with a survey question in accordance with one or more embodiments;

FIG. 4 illustrates a block diagram illustrating an overview of determining text block characteristics of a user-generated text block in accordance with one or more embodiments;

FIG. 5 illustrates an exemplary message and extracted user-generated text block in accordance with one or more embodiments;

FIG. 6 illustrates a block diagram of determining one or more keywords used in a user-generated text block in accordance with one or more embodiments;

FIGS. 7A-7B illustrate block diagrams of determining classifications for a user-generated text block;

FIG. 8 illustrates a user-generated text block and corresponding text block characteristics in accordance with one or more embodiments;

FIGS. 9A-9C illustrate block diagrams generating survey responses after determining that text block characteristics satisfy text characteristics in accordance with one or more embodiments;

FIG. 10 illustrates a block diagram of determining that text block characteristics relate to a survey question using a relevance in accordance with one or more embodiments;

FIG. 11 illustrates a block diagram of determining that text block characteristics relate to a survey question using a machine learning model in accordance with one or more embodiments;

FIG. 12 illustrates a survey response report in accordance with one or more embodiments;

FIG. 13 illustrates an example schematic diagram of an unsolicited response system in accordance with one or more embodiments;

FIG. 14 illustrates a flowchart of a series of acts for generating a survey response from a user-generated text block in accordance with one or more embodiments;

FIG. 15 illustrates a block diagram of an exemplary computing device in accordance with one or more embodiments; and

FIG. 16 illustrates an example network environment of an unsolicited response system in accordance with one or more embodiments described herein.

### DETAILED DESCRIPTION

One or more embodiments described herein include an unsolicited response system that generates responses for survey questions based on the content of user-generated text blocks (i.e., segments of text extracted from messages (e.g., email messages or social media posts) that were not composed as direct responses to the survey questions. In particular, the unsolicited response system can determine that a user-generated text block contains an answer to a survey question and then generate a response to the survey question based on the contents of the user-generated text block. Accordingly, the unsolicited response system can generate structured survey responses and survey results based on organic user-generated content that users naturally create online (e.g., via a contact email address, via social media, via help chat sessions, etc.). These responses and results can be added to other structured survey response data (e.g., responses directed received from administering electronic surveys) to generate a comprehensive response databased that includes user's thoughts, opinions, and experiences without the need for user's to directly respond to survey questions.

In general, to generate a survey response from a user-generated text block, the unsolicited response system analyzes a user-generated text block to determine one or more characteristics (e.g., keywords used, text block length, etc.) and then identifies one or more survey questions to which those characteristics relate. In some embodiments, the system determines relatedness based on a question profile for each survey question and determines whether the text block characteristics satisfy or match the question profile. Once a related survey question is identified, the unsolicited response system can use the content of the user-generated text block to generate a response for the survey question. In one or more embodiments, the unsolicited response system identifies multiple survey questions related to the text block characteristics. Consequently, the system can generate a survey response for each of the identified survey questions based on the content of the user-generated text block.

As just mentioned, the unsolicited response system can analyze a user-generated text block to determine a text block characteristic. The user-generated text block is typically included within some form of electronic communication (e.g., an email message, a social media post, chat message, etc.) that includes additional content and/or formatting imposed by the message platform. In one or more embodiments, the unsolicited response system extracts the user-generated text block from the message to exclude the additional content and/or formatting so that the text block characteristic is reflective of the user feedback included within the user-generated text block. In some embodiments, the messages are pre-existing messages. For example, the unsolicited response system can access a database storing a plurality of pre-existing messages or pre-existing user-generated text blocks that have previously been extracted.

After extraction, the unsolicited response system can analyze the user-generated text block to determine one or more text block characteristics. For example, the system can determine a keyword used within the user-generated text block (e.g., product name, location, etc.) or a length of the user-generated text block (e.g., number of words or characters used). In one or more embodiments, the unsolicited response system analyzes the user-generated text block as a whole (i.e., determines a text block characteristic that applies to the entire user-generated text block). In other instances, however, the system analyzes the user-generated text block on a sentence-by-sentence basis (i.e., determines a separate text block characteristic for each sentence of the user-generated text block) and then determines whether the text block characteristic of one of the sentences relates to a survey question.

Additionally, as mentioned above, the unsolicited response system determines whether the text block characteristic of the user-generated text block relates to a survey question of an electronic survey. In some embodiments, the unsolicited response system determines that a relation exists when the text block characteristic satisfies a text characteristic associated with a profile of a survey question. In particular, the text characteristic associated with a question indicates text that is likely useful in answering the survey question. Consequently, a satisfaction of the text characteristic by the text block characteristic indicates that content of the user-generated text block includes an answer to the survey question. For example, a text block characteristic that includes, as a keyword, the name of a product indicates that the content of the corresponding user-generated text block contains an answer to a survey question having a text characteristic that requires eligible responses to refer to the product name. Therefore, when the text block characteristic satisfies the text characteristic of the survey question, the unsolicited response system determines that the text block relates to the associated survey question.

In one or more embodiments, the unsolicited response system associates the survey question with a question profile that includes multiple text characteristics, determines multiple text block characteristics of the user-generated text block, and determines that the text block characteristics relate to the survey question when the text block characteristics satisfy one or more than one (e.g., all) of the text characteristics. In some embodiments, the unsolicited response system determines that the text block characteristics relate to the survey question by determining that a relevance of the text block characteristics satisfies a predetermine relevance threshold. In further embodiments, the unsolicited response system uses a machine learning model to determine whether the text block characteristics relate to the survey question, as will be described in greater detail below.

As further mentioned above, the unsolicited response system generates a survey response for the survey question based on content of the user-generated text block. For example, the unsolicited response system can generate multiple choice answers, free response answers, rankings, ratings, etc. In one or more embodiments, the unsolicited response system generates the survey response based on the user-generated text block itself. For example, the system can use the text contained within the user-generated text block to provide a free-form response. In some embodiments, the unsolicited response system generates the survey response based on the determined text block characteristics. To illustrate, the system may use a sentiment categorization (e.g., positive, neutral, or negative) determined through analysis of the user-generated text block content to provide a multiple choice selection or a rating. In this way, and as mentioned above, the unsolicited response system can combine survey responses generated from user-generated text blocks with direct survey responses provided by survey respondents to produce a comprehensive set of survey results.

The unsolicited response system provides several advantages over conventional systems. For example, the unsolicited response system produces more accurate results. In particular, the unsolicited response system produces results that more accurately reflect the feedback from a broad cross-section of a desired group. For example, by analyzing a user-generated text block and determining whether the resulting text block characteristics relate to survey questions (i.e., indicate that the corresponding user-generated text block answers the survey questions), the unsolicited response system provides results that more accurately reflect feedback from the desired group as a whole (i.e., reflect feedback from more members of a desired group than strictly those motivated to respond directly to the electronic survey). Similarly, the unsolicited response system provides results that more accurately reflect feedback provided on multiple data sources.

To illustrate, a consumer who has purchased a particular product may have a general habit of not participating in surveys but may post a message regarding the product on a social media page of the manufacturer. The unsolicited response system can analyze the user-generated text block derived from this message, determine whether its characteristics relate to one or more survey questions from an electronic survey, and then generate a response to those related questions based on the contents of the text block. Therefore, the unsolicited response system can produce results that reflect feedback from more members of a desired group as well as feedback that is submitted through a wide variety of platforms.

Additionally, the unsolicited response system improves efficiency of conventional electronic survey systems. In particular, by generating survey responses based on the contents of user-generated text blocks, the unsolicited response system efficiently obtains data without spending computing resources to distribute electronic surveys to recipients who will never respond. Further, by generating responses from pre-existing user-generated text blocks, the unsolicited response system can leverage the large quantity of existing data, rather than waiting for new data to become available.

Further, the unsolicited response system improves the flexibility compared to conventional electronic survey systems. In particular, by generating survey responses from user-generated text blocks that have been extracted from messages to exclude excessive content and/or formatting imposed by the message platform, the unsolicited response system flexibly incorporates valuable survey responses provided in formats that would otherwise be unacceptable to many conventional systems. In other words, the unsolicited response system enables a user to provide feedback in whatever format is desired and that feedback is still eligible to provide a survey response.

As illustrated by the foregoing discussion, the present disclosure utilizes a variety of terms to describe features and benefits of the unsolicited response system. Additional detail is now provided regarding the meaning of these terms. As used herein, the term “survey question” refers to an inquiry. In particular, a survey question refers to an inquiry that presents a question and parameters for a compatible response. For example, a survey question can include a multiple-choice question, a free-response question, rating scale question (e.g., a net promoter score (NPS) question), a rank order question, or a dichotomous question.

Additionally, as used herein, the term “user-generated text block” or “text block” refers to a segment of text. In particular, a user-generated text block refers to a segment of text that is composed by a user (e.g., an individual) as part of a message that is not a direct response to a survey question. For example, a user-generated text block can include a segment of text composed by a user as part of an email message, a text message, a social media post, chat session, or in text posted on a web site.

Further, as used herein, the term “text block characteristic” refers to a description of a user-generated text block. In particular, a text block characteristic refers to a qualitative or quantitative value that describes an attribute of a user-generated text block. For example, a text block characteristic can include a keyword used in the user-generated text block or a word embedding corresponding to a word used in the user-generated text block. Further, a text block characteristic can include a length, sentiment category, sentiment score, or text block category of the user-generated text block.

Similarly, as used herein, the term “text characteristic” refers to a description of text that is useful in answering a survey question. In particular, a text characteristic refers to a qualitative or quantitative value that describes an attribute of text (e.g., text that may be found within a user-generated text block) that is useful in answering a survey question. For example, a text characteristic can include a keyword that, if used in a user-generated text block, indicates that the user-generated text block contains text useful in answering the survey question.

Additionally, as used herein, the term “word embedding” refers to a word representation format. In particular, a word embedding refers to a numeric feature representation (e.g., a number value) corresponding to a particular word (e.g., a word used in a user-generated text block). The numeric feature representation can correspond to a position in a representation space such that the word embeddings of similar words are near one another in that space. A word embedding can be structured as a word vector containing values corresponding to the numeric feature representation.

Further, as used herein, the term “sentiment category” refers to a categorical view or attitude reflected in text. In particular, a sentiment category refers to a qualitative description of a user attitude toward a subject matter of text (e.g., the subject matter of a user-generated text block) as reflected by the contents of the text (e.g., the language used in the user-generated text block). For example, a sentiment category can classify the text as having a negative, neutral, or positive attitude towards the subject matter.

Additionally, as used herein, the term “text block category” or “text category” refers to a description of the input provided by the text. In particular, a text block category refers to a qualitative description of the input provided by the text (e.g., the input provided by a user-generated text block) with regards to a subject matter of the text as reflected by the contents of the text (e.g., the language used in the user-generated text block). For example, a text block category can include a categorization indicating that the text provides a problem, a suggestion, or an opinion with regards to the subject matter of the text.

Additionally, as used herein, a “machine learning model” refers to a computer representation that can be tuned (e.g., trained) based on inputs to approximate unknown functions. In particular, a machine-learning model can include a model that utilizes algorithms to learn from, and make predictions on, known data by analyzing the known data to learn to generate outputs that reflect patterns and attributes of the known data. For instance, a machine-learning model can include, but is not limited to, a neural network (e.g., a convolutional neural network or deep learning), a decision tree (e.g., a gradient boosted decision tree), association rule learning, inductive logic programming, support vector learning, Bayesian network, regression-based model, principal component analysis, or a combination thereof.

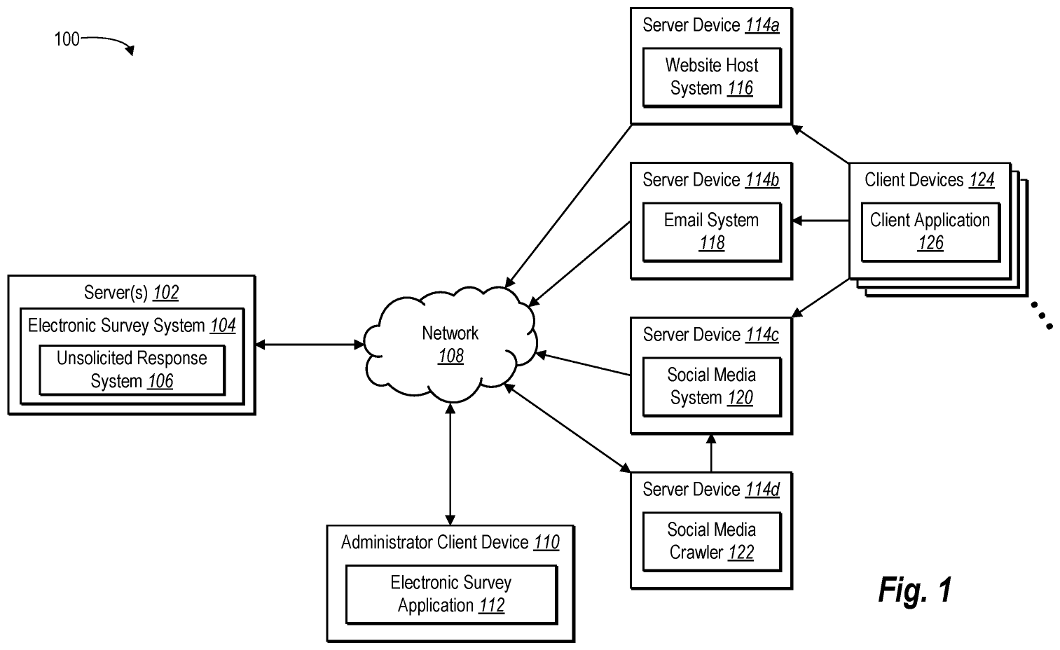

Referring now to the figures, FIG. 1 illustrates a schematic diagram of an environment 100 in which an unsolicited response system 106 operates in accordance with one or more embodiments. As illustrated in FIG. 1, the environment 100 can include a server(s) 102, a network 108, an administrator client device 110 (associated with an administrator), server devices 114a-114d, and client devices 124 (associated with corresponding users). Although the environment 100 of FIG. 1 is depicted as having a particular number of components, the environment 100 can have any number of additional or alternative components (e.g., any number of servers, client devices, databases, or other components in communication with the unsolicited response system 106 via the network 108). Similarly, although FIG. 1 illustrates a particular arrangement of the server(s) 102, the network 108, the administrator client device 110, the server devices 114a-114d, and the client devices 124, various additional arrangements are possible.

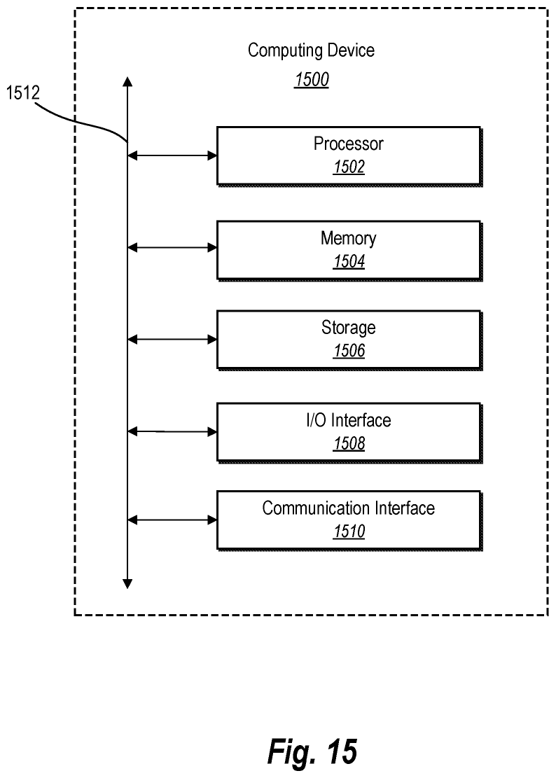

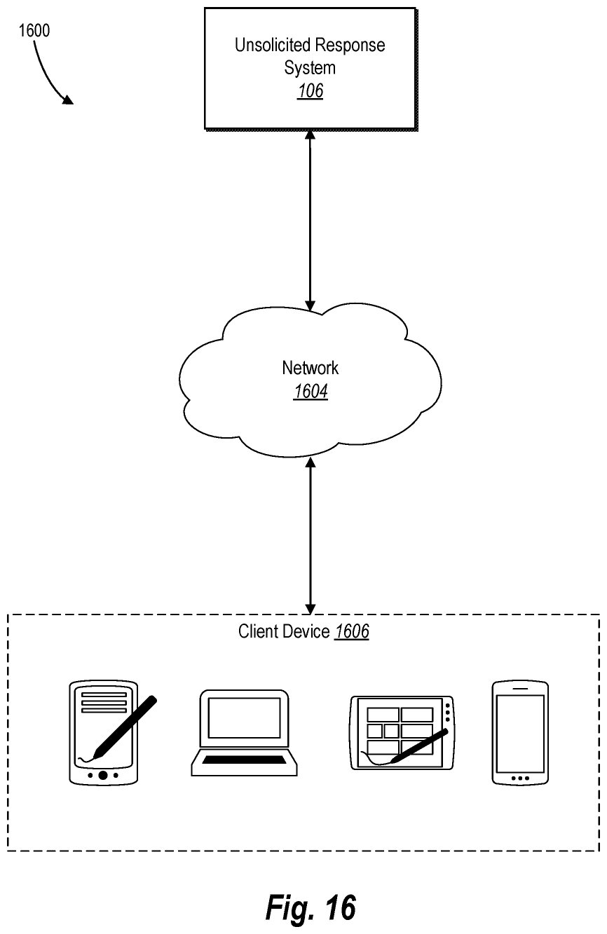

The server(s) 102, the network 108, the administrator client device 110, the server devices 114a-114d, and the client devices 124 may be communicatively coupled with each other either directly or indirectly (e.g., through the network 108, networks are discussed in greater detail below in relation to FIGS. 15-16). For example, though FIG. 1 shows the client devices 124 in direct communication with the server devices 114a-114d, in one or more embodiments, the client devices 124 can communicate with the server devices 114a-114d through the network 108. Moreover, the server(s) 102, administrator client device 110, server devices 114a-114d, and client devices 124 may include any type of computing device (including one or more computing devices as discussed in greater detail below in relation to FIG. 15).

As mentioned above, the environment includes the server(s) 102. The server(s) 102 can generate, store, receive, and/or transmit data, including data regarding electronic surveys and user-generated text blocks. For example, the server(s) 102 may receive data from the server device 114a and send data to the administrator client device 110. In one or more embodiments, the server(s) 102 can comprise a data server. The server(s) 102 can also comprise a communication server and/or a web-hosting server.

As shown in FIG. 1, the server(s) 102 can include an electronic survey system 104. In particular, the electronic survey system 104 provides functionality by which an administrator (e.g., the administrator associated with the administrator client device 110) can generate, manage, edit, and/or store electronic surveys. For example, the administrator, can access the electronic survey system 104, via the network 108, using the administrator client device 110. The electronic survey system 104 then provides many options that the administrator can use to generate a new electronic survey (i.e., generate one or more survey questions), manage the electronic survey, edit the electronic survey, select respondents to whom the electronic survey will be sent, and subsequently search for, access, and view responses to the electronic survey. The electronic survey system 104 can also provide functionality through which the server(s) 102 can transmit electronic surveys to designated respondents and receive corresponding direct responses.

Additionally, the server(s) 102 can execute or implement the unsolicited response system 106. In one or more embodiments, the unsolicited response system 106 uses the server(s) 102 to generate a survey response from a user-generated text block. For example, the server(s) 102 can receive, via the network 108, an electronic survey that includes one or more survey questions from the administrator client device 110. Additionally, the server(s) 102 can obtain a message that contains a user-generated text block—composed on one of the client devices 124—from one of the server devices 114a-114d. The server(s) 102 can then extract and analyze the user-generated text block to determine a text block characteristic and determine whether the text block characteristic relates to a survey question from the received electronic survey (i.e., determine whether the text block characteristic indicates that the user-generated text block contains text useful in answering the survey question). Upon identifying a survey question that relates to the text block characteristic, the server(s) 102 can then generate a response for the survey question. In particular, the server(s) 102 generate the survey response based on the contents of the user-generated text block. Additionally, the server(s) 102 can store the generated survey response for access by the administrator client device 110.

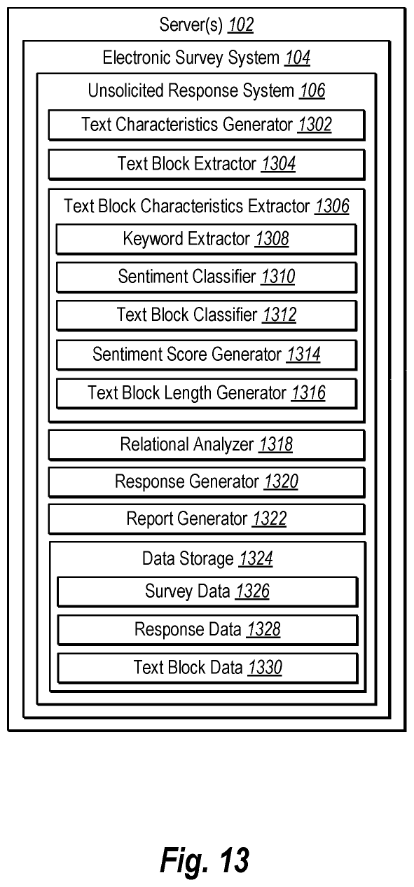

The unsolicited response system 106 can be implemented in whole, or in part, by the individual elements of the environment 100. Although FIG. 1 illustrates the unsolicited response system 106 being implemented by the server(s) 102, it will be appreciated that one or more components of the unsolicited response system 106 can be implemented in any of the components of the environment 100. The components of the unsolicited response system 106 will be discussed in more detail with regard to FIG. 13 below.

In one or more embodiments, the administrator client device 110 includes a client device that allows the administrator to create and manage electronic surveys and receive and access responses to the electronic surveys. For example, the administrator client device 110 can include a smartphone, tablet, desktop computer, laptop computer, or other electronic device. The administrator client device 110 can include one or more applications (e.g., the electronic survey application 112) that allows the administrator to create and manage electronic surveys and receive and access responses to the electronic surveys. For example, the electronic survey application 112 can include a software application installed on the administrator client device 110. Additionally, or alternatively, the electronic survey application 112 can include a software application hosted on the server(s) 102, which may be accessed by the administrator client device 110 through another application, such as a web browser.

As shown in FIG. 1, the environment 100 also includes the server devices 114a-114d. The server devices 114a-114d can generate, store, receive, and/or transmit data, including data regarding messages containing user-generated text blocks. For example, the server devices 114a-114d can include systems that obtain messages from the client devices 124 and transmit the messages to the server(s) 102. To illustrate, the server device 114a can include a website host system 116 that hosts a website (e.g., a website maintained by the administrator associated with the administrator client device 110) on which a user associated with one of the client devices 124 can post a message (e.g., review, comment, complaint, etc.). Upon receiving the message at the website host system 116, the server device 114a can forward the message to the server(s) 102. Similarly, the server device 114b can implement the email system 118 that can receive email messages from the client devices 124 and forward the email messages to the server(s) 102. Additionally, the server device 114 can implement the social media system 120 that can receive social media posts directed to a social media account maintained by the administrator associated with the administrator client device 110 and forward the social media posts to the server(s) 102. Further, the server device 114d can implement the social media crawler 122 that actively searches for social media posts directed to social media accounts not maintained by the administrator and forwards those social media posts to the server(s) 102.

In one or more embodiments, the client devices 124 include client devices that allow corresponding users to compose and submit user-generated text blocks. For example, the client devices 124 can include smartphones, tablets, desktop computers, laptop computers, or other electronic devices. The client devices 124 can include one or more applications (e.g., the client application 126) that allows the corresponding users to compose and submit the user-generated text blocks included within messages. For example, the client application 126 can include a software application installed on the client devices 124. Additionally, or alternatively, the client application 126 can include a software application hosted on the server(s) 102, which may be accessed by the client devices 124 through another application, such as a web browser.

As discussed above, the unsolicited response system 106 operates to generate a survey response from a user-generated text block. As a broad introduction, after obtaining a user-generated text block, the unsolicited response system 106 analyzes the user-generated text block to determine a text block characteristic. The unsolicited response system 106 then identifies a survey question to which the user-generated text block relates. In particular, the unsolicited response system 106 identifies the survey question by determining that the text block characteristic of the user-generated text block relates to the survey question. Subsequently, the unsolicited response system 106 generates a survey response for the survey question based on the content of the user-generated text block.

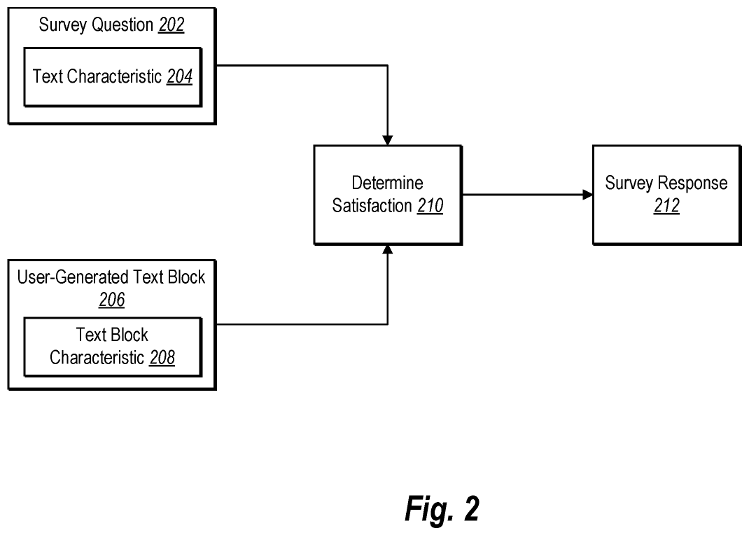

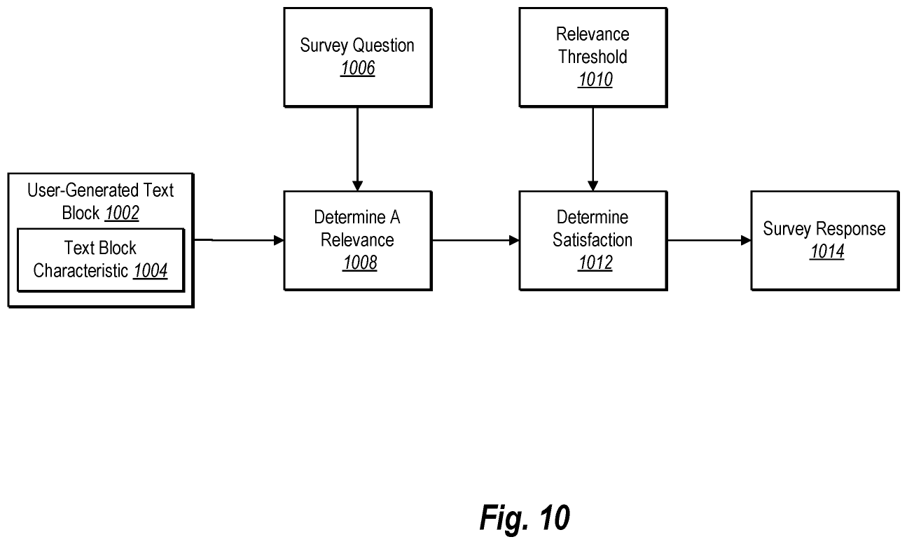

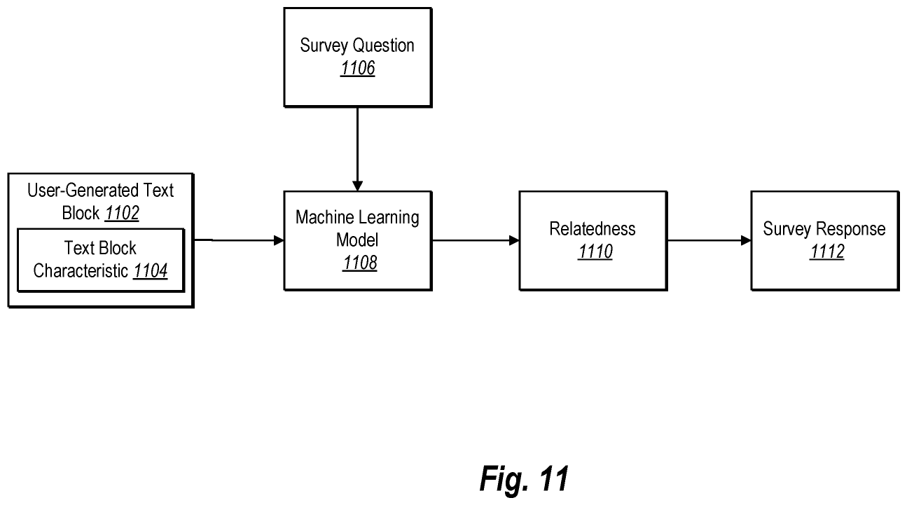

FIG. 2 illustrates a block diagram that broadly describes a process for generating a survey response for a survey question using a user-generated text block in accordance with one or more embodiments of the unsolicited response system 106. In particular, FIG. 2 (as well as many of the subsequent figures) illustrates one or more embodiments in which the unsolicited response system 106 determines that a text block characteristic of a user-generated text block relates to a survey question by associating the survey question with a text characteristic (i.e., a rule) and then determining whether that text characteristic has been satisfied by the text block characteristic. Additional embodiments determine the relatedness of text block characteristics and survey questions using other methods. For example, as will be discussed further below with respect to FIGS. 10-11, the unsolicited response system 106 can determine a relevance of a text block characteristic to the survey question or use a machine learning model to determine the relatedness of a text block characteristic and a survey question.

Additionally, one or more embodiments associate a plurality of text characteristics with a survey question and similarly determine a plurality of text block characteristics for a user-generated text block. For purposes of clarity, however, the discussion of FIG. 2 will involve embodiments using a single text characteristic and a single text block characteristic. Embodiments using multiple such characteristics will be discussed below with regards to subsequent figures.

As shown in FIG. 2, the unsolicited response system 106 uses a text characteristic 204 associated with a survey question 202 to determine whether a text block characteristic 208 of a user-generated text block 206 relates to the survey question 202. In particular, after receiving the survey question 202 (i.e., as part of an electronic survey) from an administrator client device, the unsolicited response system 106 associates the survey question 202 with the text characteristic 204. In one or more embodiments, the text characteristic 204 serves as a rule that must be satisfied by a text block characteristic for the unsolicited response system 106 to determine that the text block characteristic relates to the survey question 202 and subsequently match the survey question 202 with the corresponding user-generated text block. For example, the text characteristic 204 can indicate that text having a length of at least fifty words is useful in answering the survey question 202. Consequently, the unsolicited response system 106 matches user-generated text blocks having fifty words or more with the survey question 202 but does not match (i.e., filters out) user-generated text blocks having less than fifty words with the survey question 202.

In one or more embodiments, the unsolicited response system 106 associates the survey question 202 with the text characteristic 204 based on administrator input. For example, the administrator can request that only user-generated text blocks having at least fifty words be matched to the survey question 202, and the unsolicited response system 106 can associate the survey question 202 with the text characteristic 204 to represent that requirement. In some embodiments, however, the unsolicited response system 106 associates the text characteristic 204 without administrator input. For example, the unsolicited response system 106 can analyze the survey question 202 to identify the text characteristic 204 as one that will match the survey question 202 with the most relevant user-generated text blocks. For example, the unsolicited response system 106 can identify keywords in the survey question 202, can identify the question type, answer formats, keywords in answer choices (if applicable), and other question characteristics to generate text characteristics to associate with the survey question 202.

Accordingly, based on the unsolicited response system 106 generating the text characteristic 204 of the survey question 202, the electronic survey system 104 enables the administrator to create electronic surveys where survey questions will be matched to user-generated text blocks via the unsolicited response system 106 in the same manner as the administrator creates electronic surveys that will be transmitted to one or more respondents to obtain direct responses. In other words, the unsolicited response system 106 can operate in the background and, from the perspective of the administrator, the process of creating a new electronic survey is the same regardless of how the responses will be obtained. In some embodiments, the administrator simply creates an electronic survey and the electronic survey system 104 obtains results using both direct responses to the survey questions and user-generated text blocks.

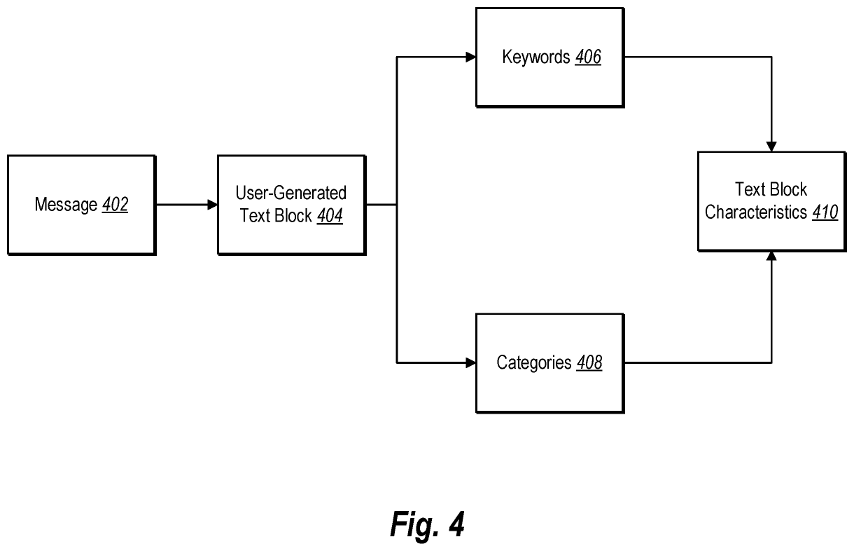

As further shown in FIG. 2, the unsolicited response system 106 uses the text block characteristic 208 of the user-generated text block 206 to determine relatedness to the survey question 202. In particular, the unsolicited response system 106 obtains a message containing the user-generated text block 206, extracts the user-generated text block 206 from the message (as will be discussed below with reference to FIG. 4) and then analyzes the user-generated text block 206 to determine the text block characteristic 208. For example, the unsolicited response system 106 can determine that a user-generated text block composed of sixty-four words has a text block length of sixty-four words.

After associating the text characteristic 204 with the survey question 202 and determining the text block characteristic 208 of the user-generated text block 206, the unsolicited response system 106 determines satisfaction 210 of the text characteristic 204 by the text block characteristic 208. In one or more embodiments, the unsolicited response system 106 determines satisfaction 210 by comparing the characteristics to determine that the text block characteristic 208 has a value required by the text characteristic 204. Continuing the example above, the unsolicited response system 106 can compare the characteristics to determine that the text block length of sixty-four words satisfies the text characteristic 204 requiring at least fifty words.

Subsequently, the unsolicited response system 106 generates a survey response 212 for the survey question 202. In particular, the unsolicited response system 106 generates the survey response 212 based on the contents of the user-generated text block 206. For example, the unsolicited response system 106 can generate the survey response 212 using the user-generated text block 206 itself (i.e., the text contained within the user-generated text block 206) or using the determined text block characteristic 208. To illustrate, where the survey question 202 calls for a free response answer, the unsolicited response system 106 can use the text of the user-generated text block 206 as the free response answer.

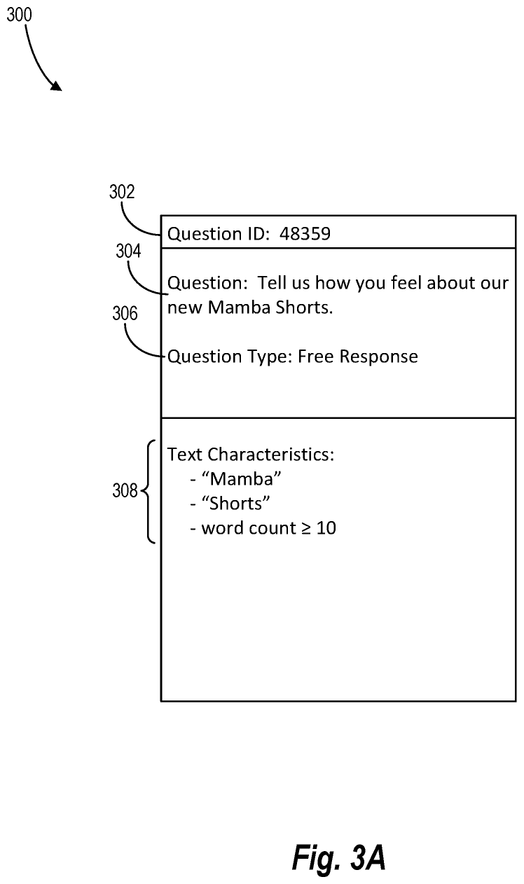

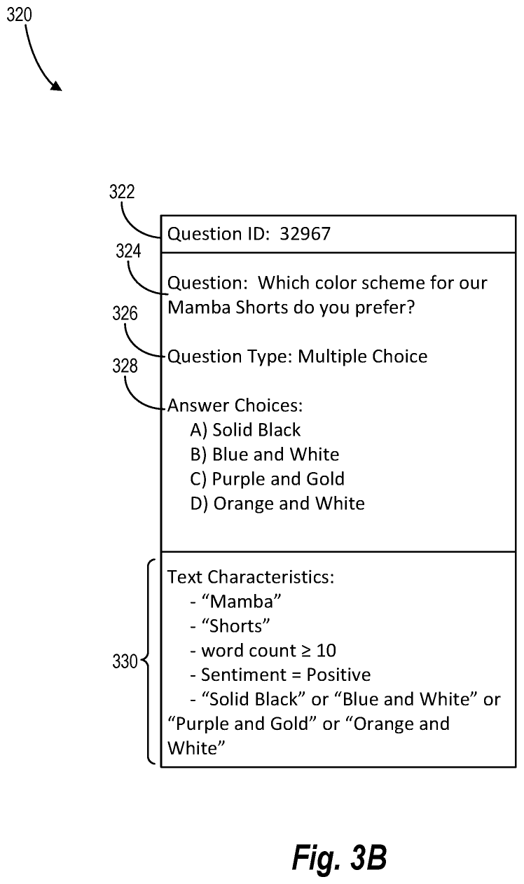

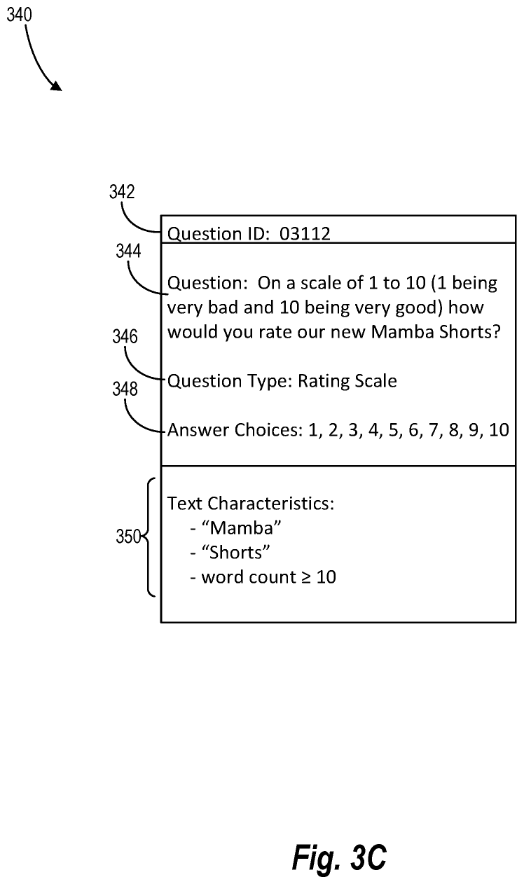

As mentioned above, in one or more embodiments, the unsolicited response system 106 determines whether the text block characteristics of a user-generated text block relate to a survey question by associating text characteristics with the survey question and then determining whether the text block characteristics satisfy the text characteristics of the survey question. FIGS. 3A-3C illustrate example survey question profiles that include text characteristics associated with each survey question. As shown in FIGS. 3A-3C, the unsolicited response system 106 can associate a plurality of text characteristics with each survey question. In one or more embodiments, the unsolicited response system 106 requires the text block characteristics of a user-generated text block to satisfy all of the text characteristics associated with a particular survey question. Some embodiments only require the text block characteristics to satisfy a subset of the text characteristics. In either case, by requiring text block characteristics to satisfy a plurality of text characteristics, the unsolicited response system 106 narrows the eligibility for answering a survey question. Consequently, the unsolicited response system matches the survey question with user-generated text blocks that provide the most relevant responses.

FIG. 3A illustrates a survey question profile 300 through which the unsolicited response system 106 associates text characteristics with a survey question in accordance with one or more embodiments. The survey question profile 300 represents metadata associated with the corresponding survey question. As shown in FIG. 3A, the survey question profile 300 includes a question ID 302, question text 304, a question type 306, and a plurality of text characteristics 308. The unsolicited response system 106 can use the question ID 302 to facilitate storage and retrieval of the survey question and can further use the question ID 302 to associate generated responses with the survey question. For example, the unsolicited response system 106 can associate the question ID 302 to a generated survey response as metadata.

The question text 304 includes the text of the survey question that is to be answered. For example, the question text 304 asks for an opinion regarding a new product referred to as “Mamba Shorts.” The question type 306 indicates the type of survey question. In one or more embodiments, the type of response generated by the unsolicited response system 106 is based on the type of survey question. For example, because the question type 306 of FIG. 3A indicates the survey question is a “free response” question, the unsolicited response system 106 generates free responses (i.e., blocks of text) as survey responses to the survey question.

As shown in FIG. 3A, the plurality of text characteristics 308 lists the text characteristics corresponding to text that will be useful in answering the associated survey question. In particular, the unsolicited response system 106 can use the plurality of text characteristics 308 to determine whether the text block characteristics of a given user-generated text block relate to the survey question. As shown in FIG. 3A, the plurality of text characteristics 308 indicates that text containing the words “Mamba” and “Shorts” and having a word count greater of at least ten will be useful in answering the survey question. Consequently, the unsolicited response system 106 determines that a set of text block characteristics relates to the survey question (i.e., satisfies the text characteristics) if the set of text block characteristics indicates that the corresponding user-generated text block includes the words “Mamba” and “Shorts” and has a word count of at least ten.

FIG. 3B illustrates a survey question profile 320 through which the unsolicited response system 106 associates text characteristics with another survey question. In particular, the survey question profile 320 corresponds to a multiple choice survey question. Similar to the survey question profile 300 of FIG. 3A, the survey question profile 320 includes a question ID 322, question text 324, a question type 326, and a plurality of text characteristics 330. Additionally, the survey question profile 320 includes a set of answer choices 328.

As can be seen from FIG. 3B, the survey question asks for a response regarding a preferred color scheme of “Mamba Shorts.” The question type 326 indicates that the survey question is a multiple choice question and that a response is to include a selection of one of the options presented within the set of answer choices 328. Accordingly, the plurality of text characteristics 330 includes representations of each answer choice, indicating that text that includes one of the answer choices from the set of answer choices 328 is useful in answering the survey question (if it also satisfies the other text characteristics). Additionally, the plurality of text characteristics 330 indicates that useful text will also suggest a positive sentiment towards the subject matter of the text. In one or more embodiments, the unsolicited response system 106 uses a sentiment text characteristic to filter out unhelpful user-generated text blocks (e.g., user-generated text blocks that suggests a negative sentiment (i.e., dislike) towards the subject matter of the text). Methods of determining a sentiment will be discussed in more detail below.

Based on the plurality of text characteristics 330, the unsolicited response system 106 determines that a set of text block characteristics relates to the survey question (i.e., satisfies the text characteristics) if the set of text block characteristics indicates that the corresponding user-generated text block includes the keywords “Mamba” and “Shorts,” has a word count of at least ten, has a positive sentiment towards the subject matter of the text block, and includes keywords that correspond to one of the answer choices presented within the set of answer choices 328.

FIG. 3C illustrates a survey question profile 340 through which the unsolicited response system 106 associates text characteristics with yet another survey question. In particular, the survey question profile 340 corresponds to a rating scale question, such as an NPS question. Similar to the survey question profile 320 of FIG. 3B, the survey question profile 340 includes a question ID 342, question text 344, a question type 346, a set of answer choices 348, and a plurality of text characteristics 350. As the survey question profile 340 corresponds to a rating scale question, each option from the set of answer choices 348 corresponds to an eligible number selection on the rating scale. Consequently, the unsolicited response system 106 will generate a survey response that includes one of the eligible number selections.

As can be seen in FIG. 3C, the survey question asks for a response regarding a rating of the “Mamba Shorts” where a low rating corresponds to a strong negative view of the product and a high rating corresponds to a strong positive view of the product. As shown in FIG. 3C, however, the plurality of text characteristics 350 does not include any text characteristic that indicates text is required to express a rating to be useful in answering the survey question (though, in one or more embodiments, the plurality of text characteristics 350 can include such a text characteristic). In other words, the text characteristics 350 allows text to imply a rating and the unsolicited response system 106 can determine the implied rating. Additionally, because the range spans the entire sentiment spectrum (i.e., from the most negative to the most positive), text implying any sentiment is useful in answering the survey question. Methods of determining an implied rating will be discussed in more detail below.

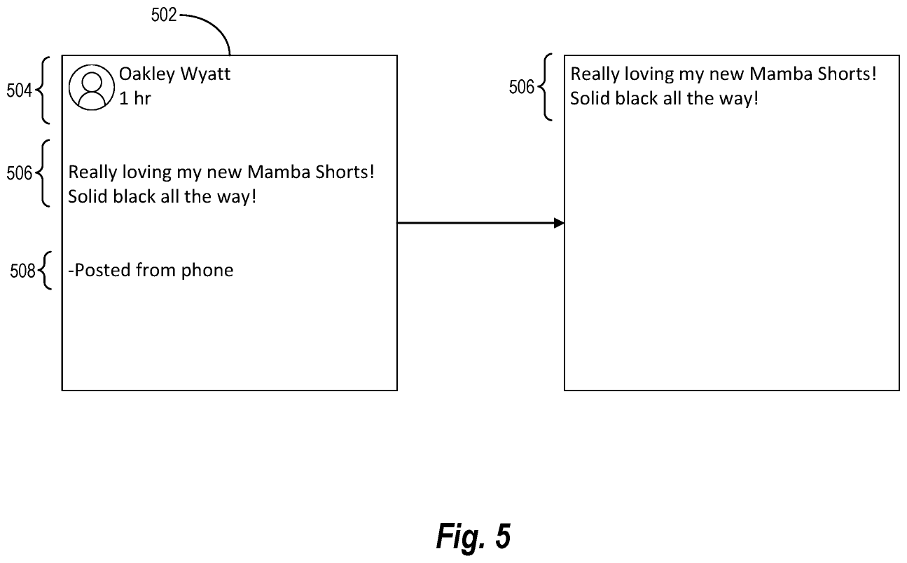

As discussed above, in one or more embodiments, the unsolicited response system 106 determines text block characteristics of a user-generated text block. FIG. 4. illustrates a block diagram providing an overview of extracting a user-generated text block from a message and then determining corresponding text block characteristics. As shown in FIG. 4, the unsolicited response system 106 obtains a message 402 (e.g., from one of the server devices 114a-114d). After obtaining the message 402, the unsolicited response system 106 extracts the user-generated text block 404 as will be discussed more with reference to FIG. 5. The unsolicited response system 106 can then determine any keywords 406 used and categorize the user-generated text block 404 under any applicable categories 408 (e.g., sentiment category and/or text block category) to obtain one or more text block characteristics 410. In one or more embodiments, the unsolicited response system 106 determines further text block characteristics, such as a user-generated text block length or a sentiment score of the user-generated text block 404.

FIG. 5 illustrates an exemplary message and the extracted user-generated text block in accordance with one or more embodiments. In particular, the message 502 and the user-generated text block 506 of FIG. 5 correspond to the message 402 and the user-generated text block 404 of FIG. 4. As seen in FIG. 5, the message 502 includes a social media post submitted from a user's smartphone device. In particular, the message 502 includes user information 504 (i.e., user name, profile picture, and message time-stamp), the user-generated text block 506, and a device add-on 508. Additionally, the message 502 can include metadata, formatting, or other added data.

As shown in FIG. 5, some of the information contained within the message 502 (e.g., the user information 504 and the device add-on 508) is information that was added to the message 502 by the social media platform used to compose the message. In some embodiments, this information is not relevant to the user feedback included within the user-generated text block 506 and, therefore, is not useful in answering survey questions (though the unsolicited response system 106 may use such information for related statistical purposes such as filtering responses by gender, age, geographic location, or other demographic information). Therefore, in some embodiments the unsolicited response system 106 operates to extract the user-generated text block 506 from the message 502, excluding any content or formatting that is not reflective of the user feedback. Broadly speaking, in one or more embodiments, the unsolicited response system 106 can exclude any applicable formatting (e.g., platform-specific formatting), embedded links, signature tags or other add-ons, user information, embedded metadata, or information regarding message forwards and/or replies. As shown in FIG. 5, upon extracting the user-generated text block 506, the unsolicited response system 106 excluded the user information 504 and the device add-on 508.

In one or more embodiments, the unsolicited response system 106 establishes one or more rules and/or stores regular expressions that facilitate exclusion of unwanted content or formatting during extraction of the user-generated text block 506. For example, the unsolicited response system 106 can maintain a database that includes add-ons (e.g., the device add-on 508) that are frequently applied to messages. Upon receiving a message (e.g., the message 502), the unsolicited response system 106 can determine whether the message contains one of the stored add-ons and, if so, remove the add-on during extraction of the user-generated text block 506. In some embodiments, however, the unsolicited response system 106 utilizes existing tools, such as text parsers, to extract user-generated text blocks from messages.

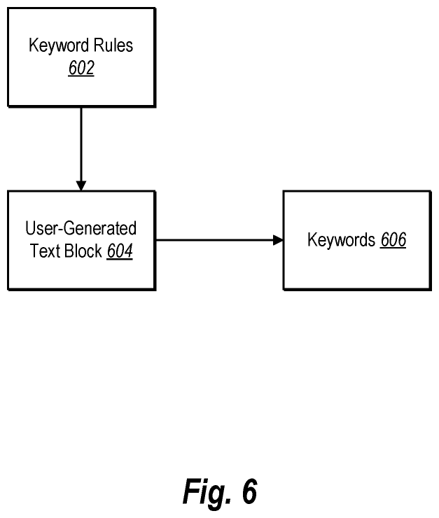

After extraction of the user-generated text block from the obtained message, the unsolicited response system 106 can analyze the user-generated text block to determine one or more text block characteristics. As discussed above with reference to FIG. 4, in one or more embodiments, the unsolicited response system 106 can determine one or more keywords used within the user-generated text block. FIG. 6 illustrates a block diagram of the unsolicited response system 106 using a set of rules to determine one or more keywords used in a user-generated text block in accordance with one or more embodiments.

As shown in FIG. 6, the unsolicited response system 106 applies keyword rules 602 to a user-generated text block 604 in order to determine included keywords 606. In one or more embodiments, the keyword rules 602 require that a word used in the user-generated text block 604 matches a predetermined keyword. For example, the unsolicited response system 106 can maintain a database of predetermined keywords (e.g., product or manufacturer names, locations, titles, etc.). When analyzing the user-generated text block 604, the unsolicited response system 106 can determine whether a word used within the user-generated text block 604 matches a predetermined keyword stored within the database in accordance with the keyword rules 602. If a match is found, the unsolicited response system 106 can add the word as one of the keywords 606 that become text block characteristics.

In some embodiments, the administrator submits one or more keywords to be stored in the database when creating an electronic survey. For example, the administrator can submit, as keywords, words contained within the text of the survey question (e.g., a product name to which the survey question refers) or words that would otherwise indicate text containing the words would be useful in answering the survey question. In some embodiments, the unsolicited response system 106 tracks words that frequently occur within survey questions or survey responses and adds those words to the database of predetermined keywords.

In one or more embodiments, the keyword rules 602 include additional or alternative rules that are used to determine the keywords 606. For example, the keyword rules 602 can include various syntactical or grammatical rules used by the unsolicited response system 106 to determine keywords 606 used within the user-generated text block 604. To illustrate, the keyword rules 602 can indicate that a word that is capitalized or place within quotation marks qualifies as a keyword.

In some embodiments, the keyword rules 602 include tools used by the unsolicited response system 106 to perform name recognition. In other words, rather than requiring that a word match a predetermined keyword, the unsolicited response system 106 can determine whether a word used in the user-generated text block 604 is similar or otherwise refers to a predetermined keyword or a word included within a survey question. For example, the text of a survey question may include the official name of a retail store; however, a user may include a popular alternative name to refer to the retail store within the user-generated text block 604. By using name recognition techniques, the unsolicited response system 106 can recognize this alternative name as a keyword. In one or more embodiments, keyword rules 602 employ a machine learning model trained for name recognition to facilitate determining keywords.

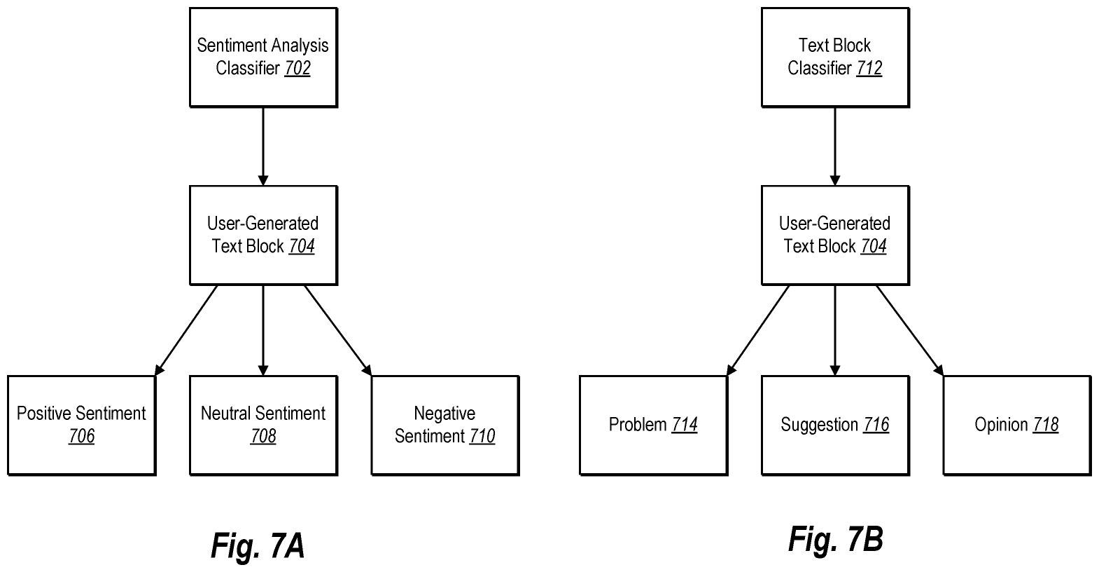

In addition to analyzing a user-generated text block to determine one or more keywords as text block characteristics, the unsolicited response system 106 can determine one or more categories as text block characteristics. FIGS. 7A-7B illustrate embodiments in which the unsolicited response system 106 applies categories to a user-generated text block. In particular, FIGS. 7A-7B illustrate block diagrams of applying a classifier to determine a category of a user-generated text block in accordance with one or more embodiments.

As shown in FIG. 7A, the unsolicited response system 106 can apply a sentiment analysis classifier 702 to a user-generated text block 704 to determine a sentiment category applicable to the user-generated text block 704. In one or more embodiments, the sentiment analysis classifier 702 categorizes the user-generated text block 704 as having a positive sentiment 706, a neutral sentiment 708, or a negative sentiment 710.

In one or more embodiments, the sentiment analysis classifier 702 determines a sentiment category based on the words used within user-generated text block. For example, the sentiment analysis classifier 702 can categorize the user-generated text block 704 as having a positive sentiment 706 for having positive words (e.g., “like,” “enjoy,” “awesome,” etc.) or has having a negative sentiment 710 for having negative words (e.g., “dislike,” “low quality,” “irritate,” etc.) In some embodiments, however, the sentiment analysis classifier 702 can additionally use other characteristics of the user-generated text block 704 when determining the sentiment category. For example, the user-generated text block 704 can include language that is somewhere between positive and neutral; however, the length of the user-generated text block 704 indicates that the user cared enough about the product to compose a lengthy message. Consequently, rather than possibly categorizing the user-generated text block 704 as having a neutral sentiment 708 based on the language alone, the sentiment analysis classifier 702 can categorize the user-generated text block 704 as having a positive sentiment 706 due to the added consideration of the length of the user-generated text block 704.

In one or more embodiments, the sentiment analysis classifier 702 determines a sentiment category applicable to the user-generated text block 704 as a whole. For example, if the user-generated text block 704 includes user feedback regarding a product, the sentiment analysis classifier 702 can determine whether that feedback included a positive sentiment 706, a neutral sentiment 708, or a negative sentiment 710 that applies to the user-generated text block 704 as a whole. In some embodiments, the sentiment analysis classifier 702 determines a sentiment category for each sentence (or clause) of the user-generated text block 704. For example, if the user-generated text block 704 includes feedback listing pros and cons of a product, the sentiment analysis classifier 702 can categorize a first sentence as having a positive sentiment 706 and a second sentence as having a negative sentiment 710. In some embodiments, the sentiment analysis classifier 702 can determine sentiment categories for each sentence as well as the user-generated text block 704 as a whole.

As shown in FIG. 7B, the unsolicited response system 106 can also apply a text block classifier 712 to the user-generated text block 704 to determine a text block category applicable to the user-generated text block 704. In one or more embodiments, the text block classifier 712 categorizes the user-generated text block 704 as containing a problem 714, a suggestion 716, or an opinion 718 with regards to the subject matter.

In one or more embodiments, the text block classifier 712 determines a text block category applicable to the user-generated text block 704 as a whole. For example, if the user-generated text block 704 includes user feedback regarding a product, the text block classifier 712 can determine whether that feedback generally describes a problem 714 that the user has with a the product, provides a suggestion 716 regarding how to improve the product, or provides an opinion 718 about the product. In some embodiments, the text block classifier 712 determines a text block category for each sentence (or clause) of the user-generated text block 704. For example, if the user-generated text block 704 includes user feedback in which the user states how useful the product is but also suggests a possible feature that could improve the quality of the product, the text block classifier 712 can categorize a first sentence as providing an opinion 718 and a second sentence as providing a suggestion. 716.

The unsolicited response system 106 can implement the sentiment analysis classifier 702 and/or the text block classifier 712 in a variety of ways. For example, in one or more embodiments, the unsolicited response system 106 implements the sentiment analysis classifier 702 and/or the text block classifier 712 using a machine learning model implementing statistical analysis (e.g., a Naïve Bayes network, a decision tree, a support vector machine, fuzzy logic, or a K-Nearest Neighbor analysis). In some embodiments, the unsolicited response system 106 implements context-based methods (e.g., Latent Semantic Analysis, lexical units analysis, syntactic rules, or semantic labeling). In further embodiments, the unsolicited response system 106 employs a neural network (e.g., Bi-directional LSTM) to determine a semantic category or a text block category.

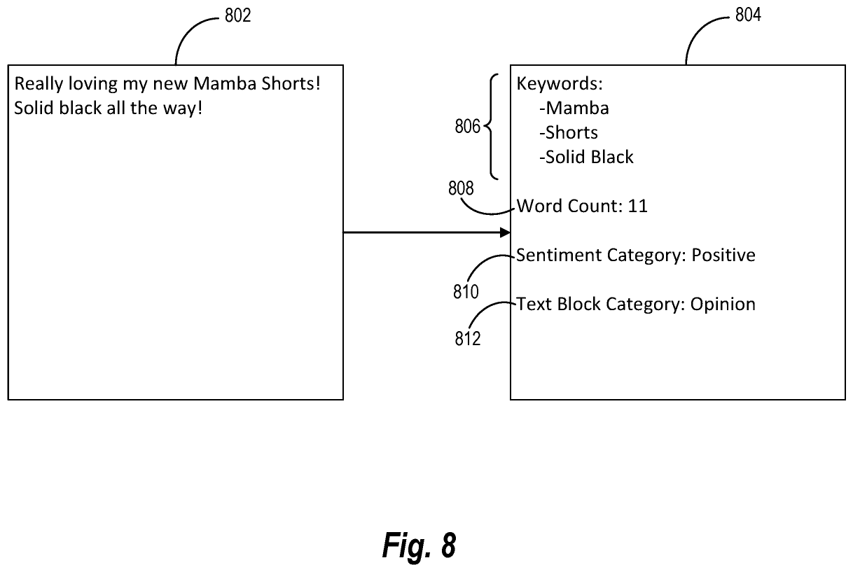

FIG. 8 illustrates the unsolicited response system 106 compiling text block characteristics of a user-generated text block in accordance with one or more embodiments. In particular, the user-generated text block 802 of FIG. 8 corresponds to the user-generated text block 506 extracted from the message 502 as discussed with reference to FIG. 5. As shown in FIG. 8, upon analyzing the user-generated text block 802, the unsolicited response system 106 determines the text block characteristics 804. As further shown in FIG. 8, the text block characteristics 804 can include one or more keywords 806 used within the user-generated text block 802 as determined using one or more of the methods discussed above with reference to FIG. 6. Additionally, the text block characteristics 804 can include a sentiment category 810 and a text block category 812 as determined using one of the methods described above with reference to FIGS. 7A-7B. Further, the text block characteristics 804 can include additional characteristics, such as the user-generated text block length 808. As shown in FIG. 8, the user-generated text block length 808 can be measured with a word count. In some embodiments, however, the user-generated text block length 808 is measured using other metrics, such as a character count.

In one or more embodiments, the text block characteristics 804 include a sentiment score. As used herein, the term “sentiment score” refers to a view or attitude reflected in text (similar to a sentiment category) but, more particularly, refers to a rating of the view or attitude on a quantitative scale. As a non-limiting example, a sentiment score can include a rating of attitude on a scale of 0 to 100 where a score between 0 and 49 represents a negative attitude toward the subject matter of the text, a score of 50 represents a neutral attitude, and a score between 51 and 100 represents a positive attitude.

By determining a sentiment score, the unsolicited response system 106 can represent the sentiment of the user-generated text block 802 on a more granular level. Further, the unsolicited response system 106 can use the sentiment score to answer survey questions in which a categorical response (e.g., a response in which the answer is categorically a negative sentiment, a neutral sentiment, or a positive sentiment) is insufficient. For example, a rating scale question asking for a user to rate their satisfaction with a product on a scale of one to ten cannot be answered with a categorical response. Therefore, using a sentiment score, the unsolicited response system 106 can answer the question with a quantitative value.

In one or more embodiments, the unsolicited response system 106 determines the sentiment score directly from the user-generated text block 802. In particular, the unsolicited response system 106 processes the user-generated text block 802 to determine the sentiment score. In some embodiments, the unsolicited response system 106 processes the user-generated text block 802 to determine the sentiment score by applying a set of rules that add to or subtract from the overall sentiment score when satisfied by the user-generated text block 802. In further embodiments, the unsolicited response system 106 applies the user-generated text block 802 to a machine learning model trained to process text and output a sentiment score.

In some embodiments, the unsolicited response system 106 determines the sentiment score using the text block characteristics 804. For example, the unsolicited response system can provide a score based on the sentiment category 810. To illustrate, on a rating scale of one to ten, the unsolicited response system 106 can determine a sentiment score of ten if the sentiment category 810 is positive (as shown in FIG. 8), a sentiment score of five if the sentiment category 810 is neutral, and a sentiment score of one if the sentiment category 810 is negative. The unsolicited response system 106 can additionally look to the user-generated text block length 808 to determine the sentiment score, where a higher length value adds to the overall score.

Further, in some embodiments, the unsolicited response system 106 can use the keywords 806 in determining the sentiment score. For example, the unsolicited response system 106 can add to or subtract from the overall sentiment score based on the keywords used in the user-generated text block 802 or by analyzing the language surrounding the keywords used (e.g., if the word “love” precedes the name of a product, the unsolicited response system 106 adds to the overall sentiment score). In one or more embodiments, the unsolicited response system 106 determines a separate sentiment score for each of the keywords 806 and includes each separate sentiment score as part of the text block characteristics 804.

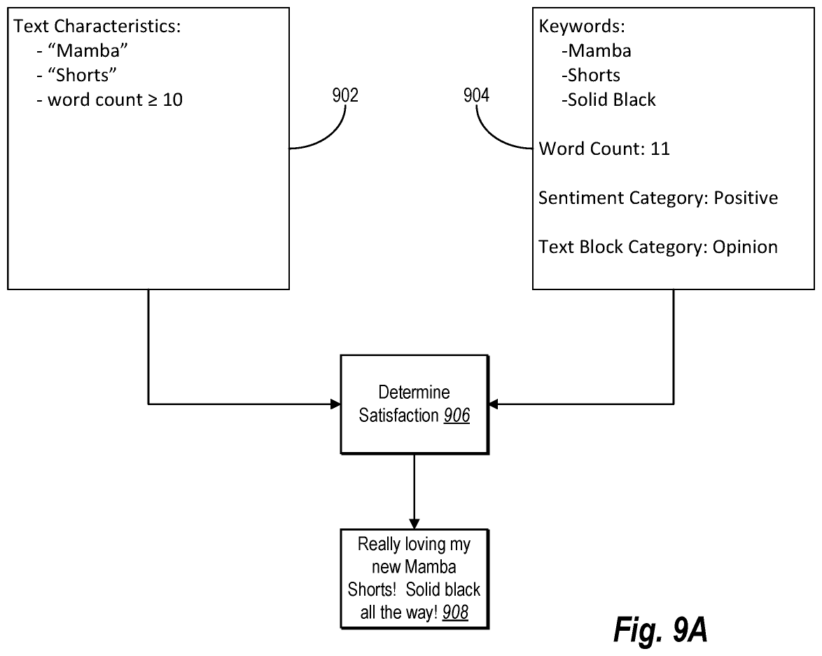

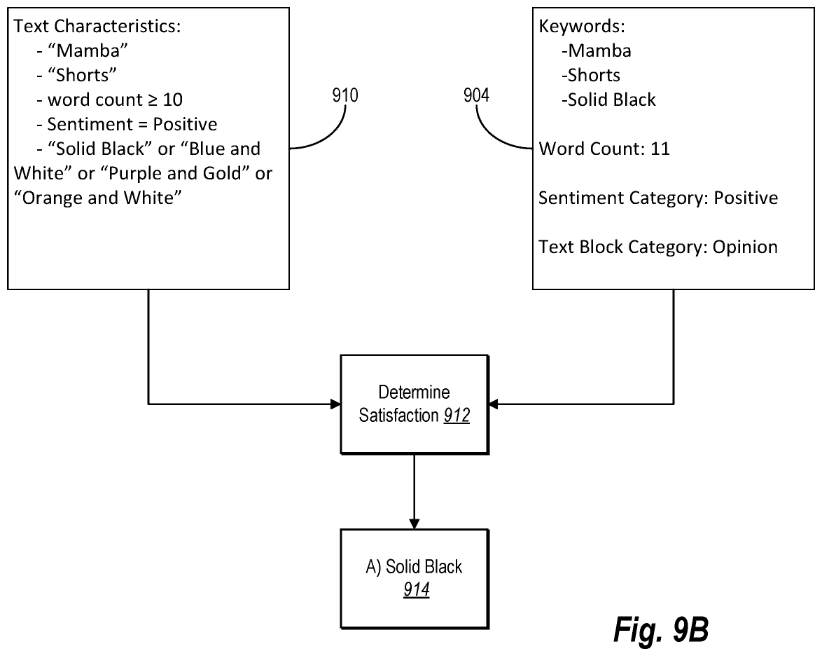

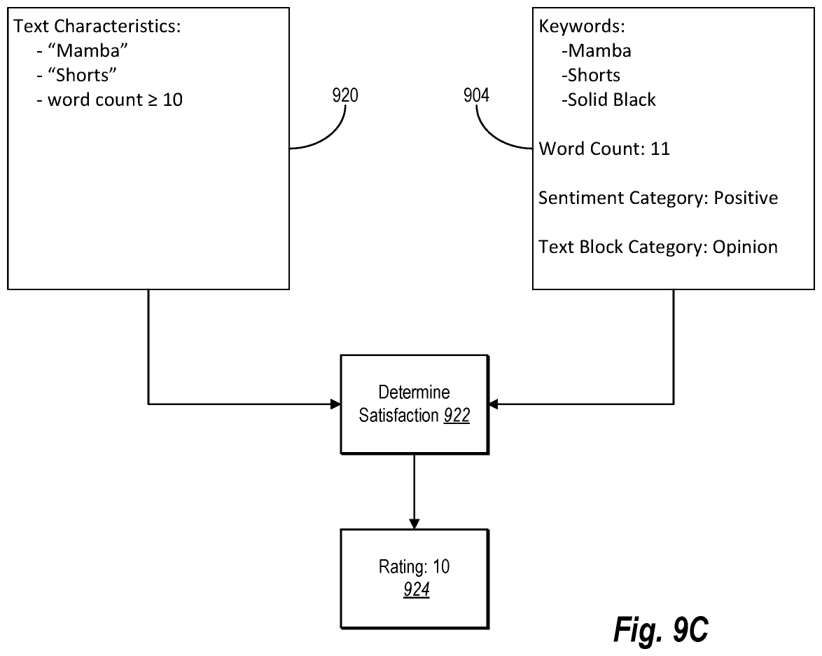

As discussed above with reference to FIG. 2, after associating text characteristics with a survey question and determining text block characteristics for a user-generated text block, the unsolicited response system 106 determines whether the text block characteristics satisfy the text characteristics. If the text block characteristics satisfy the text characteristics, then the unsolicited response system 106 determines that the text block characteristics relate to the survey question (e.g., the user-generated text block contains text that is useful in answering the survey question) and generates a survey response for the survey question. FIGS. 9A-9C illustrate block diagrams of the unsolicited response system 106 determining that the text block characteristics satisfy the text characteristics in accordance with one or more embodiments. In particular, FIGS. 9A-9C illustrate determining that the text block characteristics 804 of the user-generated text block 802 discussed with reference to FIG. 8 satisfy the text characteristics 308, 330, and 350 associated with the survey questions discussed with reference to FIGS. 3A-3C, respectively.

For example, FIG. 9A illustrates the text characteristics 902 (corresponding to the text characteristics 308 associated with the free response survey question of FIG. 3A) and the text block characteristics 904 (corresponding to the text block characteristics 804 of the user-generated text block 802 of FIG. 8). In particular, the text characteristics 902 indicate that, in general, text block characteristics must show that the corresponding user-generated text block includes the keywords “Mamba” and “Shorts” and has a minimum text block length of ten words in order for the unsolicited response system 106 to determine that the text block characteristics relate to the survey question. The text block characteristics 904 indicate that the corresponding user-generated text block includes the keywords “Mamba,” “Shorts,” and “solid slack,” has a text block length of eleven words, includes a positive sentiment, and refers to an opinion presented by the user. The unsolicited response system 106 determines satisfaction 906 of the text characteristics 902 by the text block characteristics 904 and then generates the survey response 908. As shown in FIG. 9A, because the survey question associated with the text characteristics 902 called for a free response, the unsolicited response system 106 uses the entire text from the corresponding user-generated text block as the survey response 908.

Similarly, FIG. 9B illustrates the text characteristics 910 (corresponding to the text characteristics 330 associated with the multiple choice survey question of FIG. 3B) and the text block characteristics 904. As shown in FIG. 9B, the text characteristics 910 indicate that, in general, text block characteristics must show that the corresponding user-generated text block includes the keywords “Mamba” and “Shorts,” has a minimum text block length of ten words, and includes one of the keyword pairs “solid black,” “blue and white,” “purple and gold,” or “orange and white” in order for the unsolicited response system 106 to determine that the text block characteristics relate to the survey question. The unsolicited response system 106 determines satisfaction 912 of the text characteristics 910 by the text block characteristics 904 and then generates a survey response 914. In particular, because the survey question associated with the text characteristics 910 called for a multiple choice selection, the unsolicited response system 106 uses the text block characteristics 904 to determine the selection. Specifically, because the text block characteristics 904 include the keyword pair “solid black,” the unsolicited response system 106 generates the survey response 914 to include the selection of the “solid black” option presented by the survey question.

FIG. 9C illustrates the text characteristics 920 (corresponding to the text characteristics 350 associated with the rating scale survey question of FIG. 3C) and the text block characteristics 904. In particular, the text characteristics 920 indicate that, in general, text block characteristics must show that the corresponding user-generated text block includes the keywords “Mamba” and “Shorts” and has a minimum text block length of ten words in order for the unsolicited response system 106 to determine that the text block characteristics relate to the survey question. The unsolicited response system 106 determines satisfaction 922 of the text characteristics 920 by the text block characteristics 904 and then generates a survey response 924. In particular, because the survey question associated with the text characteristics 920 called for a rating on a scale of one to ten, the unsolicited response system 106 uses the text block characteristics 904 to determine the rating. Specifically, because the text block characteristics 904 include a positive sentiment, the unsolicited response system 106 generates the survey response 924 to include the rating (i.e., a sentiment score) of ten.

As previously mentioned, the unsolicited response system 106 can generate the survey response using the user-generated text block itself or using one or more of the text block characteristics. In one or more embodiments, however, generating the survey response for the survey question involves using a machine learning model to generate the survey response based on the content of the user-generated text block. In particular, the unsolicited response system 106 can train a machine learning model to generate survey responses. After determining that the text block characteristics of a user-generated text block relate to a survey question, the unsolicited response system 106 can invoke the trained machine learning model to generate the survey response. In one or more embodiments, the unsolicited response system 106 applies the user-generated text block itself to the trained machine learning model in order to obtain the survey response. In some embodiments, the unsolicited response system 106 applies the determined text block characteristics to the trained model to obtain the survey response.

FIG. 10 illustrates a block diagram that describes another process for generating a survey response for a survey question using a user-generated text block. In particular, FIG. 10 illustrates one or more embodiments in which the unsolicited response system 106 determines that a text block characteristic 1004 relates to a survey question 1006 based on a relevance of the text block characteristic 1004 to the survey question 1006. For example, after analyzing the user-generated text block 1002 to determine the text block characteristic 1004, the unsolicited response system 106 can determine a relevance 1008 of the text block characteristic 1004 (e.g., by using a relevance meter). As shown in FIG. 10, the unsolicited response system 106 can additionally establish a relevance threshold 1010 and then determine that the text block characteristic 1004 relates to the survey question 1006 by determining satisfaction 1012 of the relevance threshold 1010 by the relevance. Upon determining that the relevance of the text block characteristic 1004 satisfies the relevance threshold 1010, the unsolicited response system 106 can generate the survey response 1014.

In some embodiments, rather than establishing a relevance threshold, the unsolicited response system 106 determines that the text block characteristic 1004 relates to the survey question 1006 if the text block characteristic 1004 has any relevance. In other embodiments, the unsolicited response system 106 determines the relevance of the text block characteristic 1004 to every available survey question and then determines that the text block characteristic 1004 relates to the survey question to which it has the most relevance.

FIG. 11 illustrates a block diagram that broadly describes yet another process for generating a survey response for a survey question using a user-generated text block in accordance with one or more embodiments. In particular, FIG. 11 illustrates embodiments in which the unsolicited response system 106 uses a machine learning model 1108 to determine that a text block characteristic 1104 of a user-generated text block 1102 relates to a survey question 1106. As shown in FIG. 11, the unsolicited response system 106 can provide the text block characteristic 1104 and the survey question 1106 to the machine learning model 1108, which outputs the relatedness 1110 of the text block characteristic 1104 to the survey question 1106. In one or more embodiments, the relatedness 1110 provides a binary determination that is positive if the machine learning model 1108 determines that the text block characteristic 1104 is related to the survey question 1106 and negative if they are not related. In some embodiments, the relatedness 1110 provides a relation score that the unsolicited response system 106 then uses to determine whether the two are sufficiently related (i.e., the relatedness satisfies a relatedness threshold). After determining that the text block characteristic 1104 is related to the survey question 1106, the unsolicited response system 106 can then generate the survey response 1112.

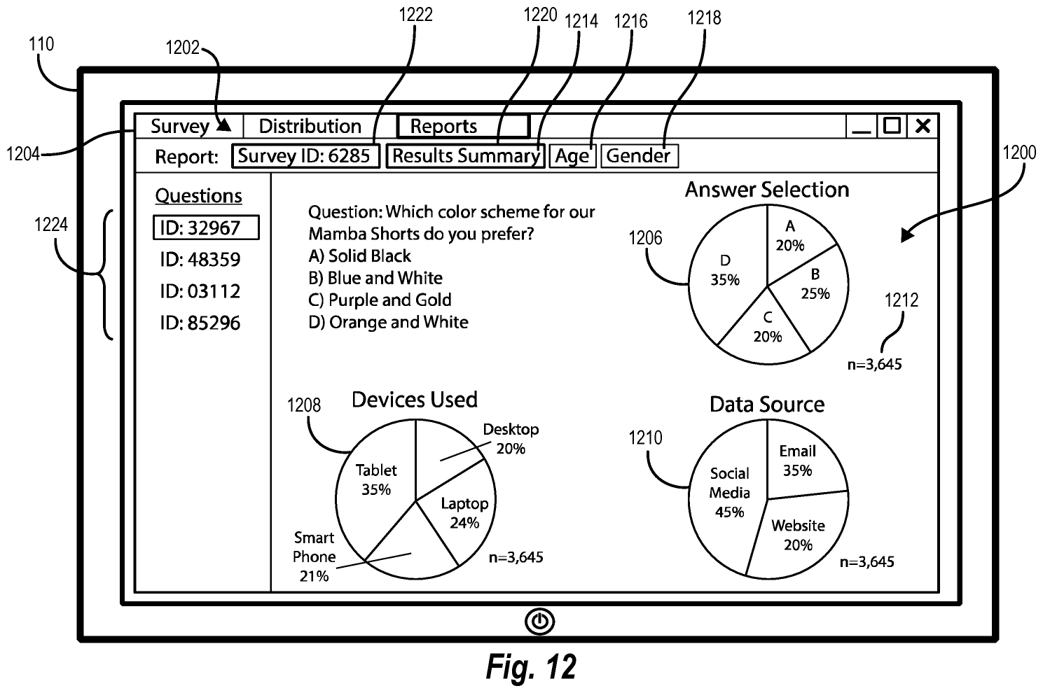

FIG. 12 illustrates a survey response report generated by the unsolicited response system 106. As shown in FIG. 12, the unsolicited response system 106 provides the survey response report 1200 for display within a graphical user interface 1202. A screen 1204 of the administrator client device 110 can present the survey response report 1200 for the associated administrator.

The survey response report 1200 includes charts providing data corresponding to survey responses collected for the multiple choice survey question of FIG. 3B. In particular, each chart provides a graphical and a numerical representation of the response data. The survey response report 1200 includes the answer selection chart 1206, the devices used chart 1208, and the data source chart 1210. The answer selection chart 1206 provides data regarding the options selected within the collection of survey responses. As indicated by the answer selection chart 1206, the most popular response to the survey question corresponds to a selection of option D, which was selected by thirty-five percent of all survey responses. The devices used chart 1208 provides data regarding the devices that were used to compose the message used by the unsolicited response system 106 to generate a response. The data source chart 1210 provides data regarding the source through which the survey response was obtained. As can be seen in FIG. 12, the data source chart 1210 indicates that the survey response report 1200 accounts only for survey response that were generated by the unsolicited response system 106 based on the contents of user-generated text blocks. In some embodiments, the survey response report 1200 also accounts for survey responses obtained from respondents as direct responses to the survey question. In addition to the charts 1206, 1208, and 1210, the survey response report 1200 provides the response total 1212 indicating the number of survey responses on which the charts 1206, 1208, and 1210 are based.

In addition to generating survey response reports for generated survey responses, the unsolicited response system 106 provides selectable options to generate a survey response report showing different characteristics of the composing users in isolation. As shown in FIG. 12, for example, the survey response report 1200 includes a results summary option 1214, an age-classification option 1216, and a gender-classification option 1218. A report indicator 1220 surrounds the results summary option 1214 to indicate that the survey response report 1200 currently includes a composite summary of the survey responses.

When the unsolicited response system 106 receives an indication that the age-classification option 1216 or the gender-classification option 1218 has been selected, however, the unsolicited response system 106 updates the survey response report 1200 to include data corresponding to an age classification or a gender classification, respectively. In each case, however, the updated survey response report shows data representing a single user characteristic. For example, the age-classification option 1216 triggers the unsolicited response system 106 to update the survey response report 1200 to include an age classification for each of the answer selection chart 1206, the devices used chart 1208, and the data source chart 1210. To illustrate, the unsolicited response system 106 can update the survey response report 1200 to divide each of the charts 1206, 1208, and 1210 into two or more sub-charts where each sub-chart shows the corresponding data with respect to an age category.

As shown in FIG. 12, the survey response report 1200 further includes a survey selector 1222 by which an administrator can select an electronic survey and a survey question selection menu 1224 by which the administrator can select a survey question associated with the selected electronic survey. In one or more embodiments, selection of the survey selector 1222 provides a dropdown menu that lists the electronic surveys having viewable results. In response to an administrator selecting a survey, the unsolicited response system 106 can update the survey question selection menu 1224 to list the survey questions corresponding to the selected electronic survey. When the administrator selects one of the listed survey questions, the unsolicited response system 106 can then update the survey response report 1200 to reflect the data corresponding to the selected survey question.

Turning now to FIG. 13, this figure illustrates a detailed schematic diagram of an example architecture of the unsolicited response system 106. As shown, the unsolicited response system can be part of the server(s) 102 and the electronic survey system 104. Additionally, the unsolicited response system 106 can include, but is not limited to, a text characteristics generator 1302, a text block extractor 1304, a text block characteristics extractor 1306, a relational analyzer 1318, a response generator 1320, a report generator 1322, and data storage 1324.

In one or more embodiments, each of the components of the unsolicited response system 106 are in communication with one another using any suitable communication technologies. Additionally, the components of the unsolicited response system 106 can be in communication with one or more other devices including the administrator client device of an administrator. It will be recognized that, although the components of the unsolicited response system 106 are shown to be separate in FIG. 13, any of the components can be combined into fewer components, such as a single component, or divided into more components as may server a particular implementation. Furthermore, although the components of FIG. 13 are described in connection with the unsolicited response system1 06, at least some components for performing operations in conjunction with the unsolicited response system 106 described herein can be implemented on other devices within the environment.

The components of the unsolicited response system 106 can include software, hardware, or both. For example, the components of the unsolicited response system 106 can include one or more instructions stored on a non-transitory computer readable storage medium and executable by processors of one or more computing devices or, alternatively, by servers (e.g., the server(s) 102) of a system. When executed by the one or more processors or servers, the computer-executable instructions of the unsolicited response system 106 can cause the computing device or system to perform the analysis and response generation functions described herein. Alternatively, the components of the unsolicited response system 106 can comprise hardware, such as a special purpose processing device to perform a certain function or group of functions. Additionally, or alternatively, the components of the unsolicited response system 106 can include a combination of computer-executable instructions and hardware.

Furthermore, the components of the unsolicited response system 106 performing the functions described herein with respect to the unsolicited response system 106 can, for example, be implemented as part of a stand-alone application, as a module of an application, as a plug-in for applications, as a library function or functions that can be called by other applications, and/or as a cloud-computing model. Thus, the components of the unsolicited response system 106 can be implemented as part of a stand-alone application on a personal computing device or a mobile device. Alternatively, or additionally, the components of the unsolicited response system 106 can be implemented in any application that allows for the creation and management of electronic surveys.

As mentioned, the unsolicited response system 106 can include the text characteristics generator 1302 to associated text characteristics with a survey question. In particular, the text characteristics generator 1302 associates a survey question of an electronic survey with text characteristics that correspond to text useful in answering the survey question. In one or more embodiments, the text characteristics generator 1302 analyzes the survey question and determines which text characteristics correspond to useful text. In some embodiments, the text characteristics generator 1302 can accept input from an administrator and associates text characteristics with the survey question that reflects the administrator input. For example, the administrator can select filters that indicate criteria a user-generated text block must satisfy to be eligible to answer the survey question. The text characteristics generator 1302 can then determine text characteristics based on the selected filters and associate the characteristics with the survey question.

As shown in FIG. 13, the unsolicited response system 106 also includes the text block extractor 1304. In particular, the text block extractor 1304 receives a message and extracts the included user-generated text block, excluding any additional formatting and/or content. For example, the text block extractor 1304 can receive a social media post and extract the corresponding user-generated text block to exclude formatting, user information, metadata, and timestamp information added by the social media platform.

As shown in FIG. 13, the unsolicited response system 106 further includes the text block characteristics extractor 1306. In particular, the text block characteristics extractor 1306 includes the keyword extractor 1308, the sentiment classifier 1310, the text block classifier 1312, the sentiment score generator 1314, and the text block length generator 1316. The keyword extractor 1308 analyzes the user-generated text block provided by the text block extractor 1304 and determines one or more included keywords. In one or more embodiments, the keyword extractor 1308 applies a set of keyword rules to the user-generated text block to determine the included keywords as discussed above with reference to FIG. 6. The sentiment classifier 1310 analyzes the user-generated text block to apply a sentiment category. For example, in one or more embodiments, the sentiment classifier 1310 can apply a positive sentiment, a neutral sentiment, or a negative sentiment to the user-generated text block as discussed above with reference to FIG. 7A. The text block classifier 1312 analyzes the user-generated text block to apply a text block category. For example, in one or more embodiments, the text block classifier 1312 can categorize the user-generated text block as presenting a problem, a suggestion, or an opinion as discussed above with reference to FIG. 7B.

The sentiment score generator 1314 determines a numerical value to represent a sentiment of the user-generated text block. For example, the sentiment score generator 1314 can determine a sentiment score on a scale between zero and one hundred where a lower sentiment score corresponds to a more negative sentiment and a higher sentiment score corresponds to a more positive sentiment. In one or more embodiments, the sentiment score generator 1314 analyzes the user-generated text block to determine a sentiment score. In some embodiments, however, the sentiment score generator 1314 determines the sentiment score based on the other text block characteristics, such as the sentiment category.

The text block length generator 1316 analyzes the user-generated text block to determine the length of the user-generated text block. In some embodiments, the text block length generator measures the length of the user-generated text block in the number of words included. In some embodiments, the text block length generator 1316 measures the number of characters used within the user-generated text block.

As shown in FIG. 13, the unsolicited response system 106 additionally includes the relational analyzer 1318. The relational analyzer 1318 determines whether the text block characteristics determined by the text block characteristics extractor 1306 relate to a survey question. In particular, the relational analyzer 1318 can determine a relation by determining that the text block characteristics satisfy the text characteristics associated with the survey question by the text characteristics generator 1302. For example, the relational analyzer 1318 can compare text block characteristics with a set of text characteristics that require at least ten words and inclusion of the keywords “Mamba” and “Shorts.” If the text block characteristics indicate that the corresponding user-generated text block has a user-generated text block length of twenty words and includes the keywords “Mamba” and “Shorts,” the relational analyzer 1318 determines that the text block characteristics relate to the survey question.

Further, as shown in FIG. 13, the unsolicited response system 106 includes the response generator 1320. In particular, if the relational analyzer 1318 determines that text block characteristics of a user-generated text block relate to a survey question, the response generator 1320 generates a survey response for that survey question based on the content of the user-generated text block. In one or more embodiments, the response generator 1320 generates a survey response using the user-generated text block itself (e.g., when the survey question calls for a free response). In some embodiments, the response generator 1320 generates the survey response using one or more of the text block characteristics (e.g., when the survey question asks for the response to rate a particular product). In some embodiments, the response generator 1320 invokes a machine learning model trained to generate survey responses.

As shown in FIG. 13, the unsolicited response system 106 also includes the report generator 1322. In particular, the report generator 1322 aggregates the survey responses generated by the response generator 1320 and generates survey response reports (e.g., the survey response report 1200 discussed above with reference to FIG. 12). As part of generating a report, the report generator 1322 performs analyses on the collected survey responses, organizes the analytics, and renders a user interface for display on an administrator device.

As shown in FIG. 13, the unsolicited response system 106 further includes data storage 1324. In particular, data storage 1324 includes survey data 1326, response data 1328, and text block data 1330. Survey data 1326 stores data regarding electronic surveys. In particular, survey data 1326 can store survey questions included within each electronic survey as well as the text characteristics associated with each survey question by the text characteristics generator 1302. Response data 1328 can store the survey responses generated by the response generator 1320. Response data 1328 can provide the stored survey responses to the report generator 1322 to generate the survey response reports. Text block data 1330 stores user-generated text blocks extracted from messages by the text block extractor 1304. Further, text block data 1330 can store the text block characteristics of each user-generated text block.

In one or more embodiments, the unsolicited response system 106 further includes a relevance meter (not shown). In particular, the relevance meter can determine a relevance of text block characteristics to a survey question and the relational analyzer 1318 can then determine whether the relevance indicates that the text block characteristics relate to the survey question (e.g., determine whether the relevance satisfies a relevance threshold) as discussed above with reference to FIG. 10. In some embodiments, the unsolicited response system 106 includes a machine learning model (not shown) trained to determine a relationship between text block characteristics and a survey question. In particular, the relational analyzer 1318 can include a machine learning model. The unsolicited response system 106 can apply text block characteristics provided by the text block characteristic extractor 1306 and a survey question to the relational analyzer 1318, which invokes the machine learning model to determine whether the text block characteristics relate to the survey question as discussed above with reference to FIG. 11.

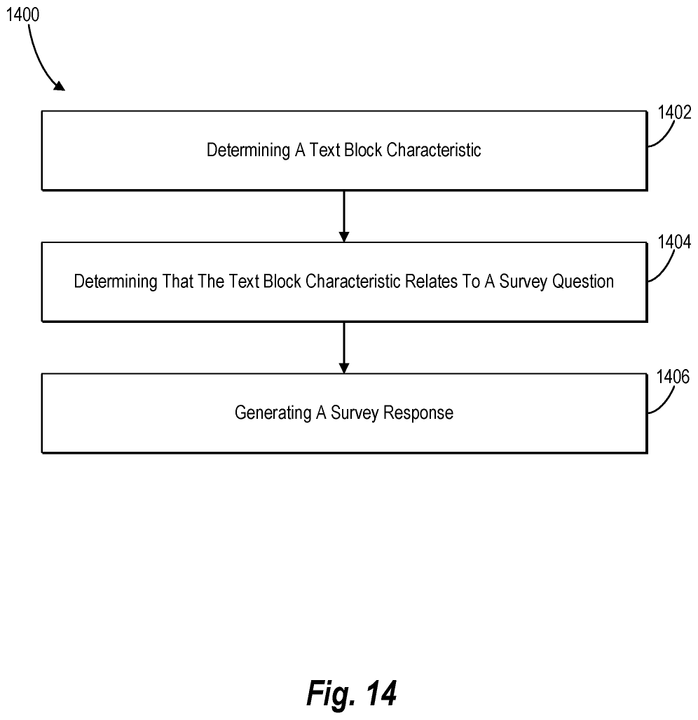

Turning now to FIG. 14, this figure illustrates a series of acts 1400 for generating survey responses from user-generated text blocks. While FIG. 14 illustrates acts according to one embodiment, alternative embodiments may omit, add to, reorder, and/or modify any of the acts shown in FIG. 14. The acts of FIG. 14 can be performed as part of a method. In one or more embodiments, a non-transitory computer readable storage medium can comprise instructions that, when executed by one or more processors, cause a computing device to perform the acts of FIG. 14. In still further embodiments, a system can perform the acts of FIG. 14.

The series of acts 1400 includes an act 1402 of determining a text block characteristic. For example, act 1402 involves analyzing a user-generated text block to determine a text block characteristic of the user-generated text block. In one or more embodiments, the user-generated text block is derived from an email, a social media post, or a message posted on a website. Further, in one or more embodiments, analyzing the user-generated text block to determine a text block characteristic includes analyzing a first sentence of the user-generated text block to determine a first text block characteristic and analyzing a second sentence of the user-generated text block to determine a second text block characteristic. In other words, the unsolicited response system 106 can analyze each sentence of the user-generated text block to determine a separate text block characteristic. In some embodiments, the unsolicited response system 106 determines multiple text block characteristics even when analyzing the user-generated text block as a whole (i.e., each text block characteristic applies to the user-generated text block in its entirety).

The series of acts 1400 also includes an act 1404 of determining that the text block characteristic relates to a survey question. For example, act 1404 involves identifying a survey question of an electronic survey based on determining that the text block characteristic of the user-generated text block relates to the survey question of the electronic survey. In one or more embodiments, the unsolicited response system associates the survey question with a text characteristic that corresponds to text useful to answering the survey question. Consequently, determining that the text block characteristic of the user-generated text block relates to the survey question includes determining that the text block characteristic of the user-generated text block satisfies the text characteristic. In some embodiments, determining that the text block characteristic of the user-generated text block relates to the survey question includes determining that a relevance of the text block characteristic to the survey question satisfies a relevance threshold. In further embodiments, determining that the text block characteristic of the user-generated text block relates to the survey question includes using a machine learning model to determine that the text block characteristic relates to the survey question. In embodiments where the unsolicited response system 106 analyzes a first sentence of the user-generated text block to determine a first text block characteristic and a second sentence of the user-generated text block to determine a second text block characteristic, determining that the text block characteristic of the user-generated text block relates to the survey question of the electronic survey includes determining that the first text block characteristic or the second text block characteristic relates to the survey question.

In one or more embodiments, the text block characteristic of the user-generated text block includes a user-generated text block length, one or more keywords, a sentiment score, a sentiment category, or a text block category. In some embodiments, the text block category categorizes the user-generated text block as a problem, a suggestion, or an opinion.

Additionally, the series of acts 1400 includes an act 1406 of generating a survey response. For example, act 1406 involves generating a survey response for the survey question based on content of the user-generated text block. In one or more embodiments, the unsolicited response system 106 generates the survey response using the user-generated text block itself (e.g., where the survey question calls for a free response). In some embodiments, the unsolicited response system 106 generates the survey response using one or more of the text block characteristics (e.g., when the survey question asks for the response to rate a particular product). In some embodiments, generating the survey response for the survey question comprises using a machine learning model to generate the survey response based on the content of the user-generated text block. Specifically, the unsolicited response system 106 can apply the survey question and the text block characteristics of the user-generated text block (or the user-generated text block itself) to a machine learning model, which is trained to generate a survey response.

In one or more embodiments, the series of acts 1400 further includes acts for determining that the text block characteristic of the user-generated text block relates to a second survey question of the electronic survey and then generating a second survey response for the second survey question based on the content of the user-generated text block. In particular, the unsolicited response system 106 can generate survey responses for multiple survey questions based on the content of a single user-generated text block.

In one or more embodiments, the series of acts 1400 further includes acts for accessing a text block database comprising a plurality of pre-existing user-generated text blocks that comprises the user-generated text block. In particular, the unsolicited response system 106 can use newly created survey questions to extract data from user-generated text blocks that were composed before creation of the survey questions. In such embodiments, identifying the survey question of the electronic survey includes analyzing each of the plurality of pre-existing user-generated text blocks to determine text blocks that relate to the survey question and generating the survey response for the survey question includes generating survey responses based on contents of each pre-existing user-generated text block from the text blocks determined to relate to the survey question.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 15 illustrates a block diagram of exemplary computing device 1500 that may be configured to perform one or more of the processes described above. One will appreciate that the server(s) 102, the administrator client device 110, and/or client devices 124 may comprise one or more computing devices such as computing device 1500. As shown by FIG. 15, computing device 1500 can comprise processor 1502, memory 1504, storage device 1506, I/O interface 1508, and communication interface 1510, which may be communicatively coupled by way of communication infrastructure 1512. While an exemplary computing device 1500 is shown in FIG. 15, the components illustrated in FIG. 15 are not intended to be limiting. Additional or alternative components may be used in other embodiments. Furthermore, in certain embodiments, computing device 1500 can include fewer components than those shown in FIG. 15. Components of computing device 1500 shown in FIG. 15 will now be described in additional detail.

In particular embodiments, processor 1502 includes hardware for executing instructions, such as those making up a computer program. As an example, and not by way of limitation, to execute instructions, processor 1502 may retrieve (or fetch) the instructions from an internal register, an internal cache, memory 1504, or storage device 1506 and decode and execute them. In particular embodiments, processor 1502 may include one or more internal caches for data, instructions, or addresses. As an example, and not by way of limitation, processor 1502 may include one or more instruction caches, one or more data caches, and one or more translation lookaside buffers (TLBs). Instructions in the instruction caches may be copies of instructions in memory 1504 or storage device 1506.

Memory 1504 may be used for storing data, metadata, and programs for execution by the processor(s). Memory 1504 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1504 may be internal or distributed memory.

Storage device 1506 includes storage for storing data or instructions. As an example, and not by way of limitation, storage device 1506 can comprise a non-transitory storage medium described above. Storage device 1506 may include a hard disk drive (HDD), a floppy disk drive, flash memory, an optical disc, a magneto-optical disc, magnetic tape, or a Universal Serial Bus (USB) drive or a combination of two or more of these. Storage device 1506 may include removable or non-removable (or fixed) media, where appropriate. Storage device 1506 may be internal or external to computing device 1500. In particular embodiments, storage device 1506 is non-volatile, solid-state memory. In other embodiments, Storage device 1506 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1508 allows a user to provide input to, receive output from, and otherwise transfer data to and receive data from computing device 1500. I/O interface 1508 may include a mouse, a keypad or a keyboard, a touch screen, a camera, an optical scanner, network interface, modem, other known I/O devices or a combination of such I/O interfaces. I/O interface 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 1508 is configured to provide graphical data to a display for presentation to a user. The graphical data may be representative of one or more graphical user interfaces and/or any other graphical content as may serve a particular implementation.

Communication interface 1510 can include hardware, software, or both. In any event, communication interface 1510 can provide one or more interfaces for communication (such as, for example, packet-based communication) between computing device 1500 and one or more other computing devices or networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 1510 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1510 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1510 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1512 may include hardware, software, or both that couples components of computing device 1500 to each other. As an example and not by way of limitation, communication infrastructure 1512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 16 illustrates an example network environment 1600 of an unsolicited response system 106, such as embodiments of the unsolicited response system described herein. The network environment 1600 includes the unsolicited response system 106 and a client device 1606 connected to each other by a network 1604. Although FIG. 16 illustrates a particular arrangement of the unsolicited response system 106, the client device 1606, and the network 1604, one will appreciate that other arrangements of the network environment 1600 are possible. For example, a client device of the client device 1606 is directly connected to the unsolicited response system 106. Moreover, this disclosure contemplates any suitable number of client systems, unsolicited response systems, and networks are possible. For instance, the network environment 1600 includes multiple client systems.

This disclosure contemplates any suitable network. As an example, one or more portions of the network 1604 may include an ad hoc network, an intranet, an extranet, a VPN, a LAN, a wireless LAN, a WAN, a wireless WAN, a MAN, a portion of the Internet, a portion of the Public Switched Telephone Network (PSTN), a cellular telephone network, a safelight network, or a combination of two or more of these. The term “network” may include one or more networks and may employ a variety of physical and virtual links to connect multiple networks together.

In particular embodiments, the client device 1606 is an electronic device including hardware, software, or embedded logic components or a combination of two or more such components and capable of carrying out the appropriate functionalities implemented or supported by the client system. As an example, the client device 1606 includes any of the computing devices discussed above. The client device 1606 may enable a user at the client device 1606 to access the network 1604. Further, the client device 1606 may enable a user to communicate with other users at other client systems.

In some embodiments, the client device 1606 may include a web browser and may have one or more add-ons, plug-ins, or other extensions. The client device 1606 may render a web page based on the HTML files from the server for presentation to the user. For example, the client device 1606 renders the graphical user interface described above.

In one or more embodiments, the unsolicited response system 106 includes a variety of servers, sub-systems, programs, modules, logs, and data stores. In some embodiments, the unsolicited response system 106 includes one or more of the following: a web server, action logger, API-request server, relevance-and-ranking engine, content-object classifier, notification controller, action log, third-party-content-object-exposure log, inference module, authorization/privacy server, search module, user-targeting module, user-interface module, user-profile store, connection store, third-party content store, or location store. The unsolicited response system 106 may also include suitable components such as network interfaces, security mechanisms, load balancers, failover servers, management-and-network-operations consoles, other suitable components, or any suitable combination thereof.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
analyzing a user-generated text block to determine a text block characteristic of the user-generated text block;
identifying a survey question of an electronic survey based on determining that the text block characteristic of the user-generated text block relates to the survey question of the electronic survey; and
generating a survey response for the survey question based on content of the user-generated text block.

2. The method of claim 1, further comprising:
associating the survey question with a text characteristic that corresponds to text useful to answering the survey question,
wherein determining that the text block characteristic of the user-generated text block relates to the survey question comprises determining that the text block characteristic of the user-generated text block satisfies the text characteristic.

3. The method of claim 1, further comprising accessing a text block database comprising a plurality of pre-existing user-generated text blocks that comprises the user-generated text block,
wherein:
identifying the survey question of the electronic survey comprises analyzing each of the plurality of pre-existing user-generated text blocks to determine text blocks that relate to the survey question; and
generating the survey response for the survey question comprises generating survey responses based on contents of each pre-existing user-generated text block from the text blocks determined to relate to the survey question.

4. The method of claim 1, wherein generating the survey response for the survey question comprises using a machine learning model to generate the survey response based on the content of the user-generated text block.

5. The method of claim 1, further comprising:
determining that the text block characteristic of the user-generated text block relates to a second survey question of the electronic survey; and
generating a second survey response for the second survey question based on the content of the user-generated text block.

6. The method of claim 1, wherein:
analyzing the user-generated text block to determine the text block characteristic of the user-generated text block comprises analyzing a first sentence of the user-generated text block to determine a first text block characteristic and analyzing a second sentence of the user-generated text block to determine a second text block characteristic; and
determining that the text block characteristic of the user-generated text block relates to the survey question of the electronic survey comprises determining that the first text block characteristic or the second text block characteristic relates to the survey question.

7. The method of claim 1, wherein determining that the text block characteristic of the user-generated text block relates to the survey question comprises determining that a relevance of the text block characteristic to the survey question satisfies a relevance threshold.

8. The method of claim 1, wherein determining that the text block characteristic of the user-generated text block relates to the survey question comprises using a machine learning model to determine that the text block characteristic relates to the survey question.

9. The method of claim 1, wherein the text block characteristic of the user-generated text block comprises at least one of a user-generated text block length, one or more keywords, one or more word embeddings, a sentiment score, a sentiment category, or a text block category.

10. The method of claim 9, wherein the text block characteristic of the user-generated text block comprises the text block category, and wherein the text block category categorizes the user-generated text block as a problem, a suggestion, or an opinion.

11. The method of claim 1, wherein the user-generated text block is derived from an email, a social media post, or a message posted on a website.

12. A non-transitory computer readable storage medium, comprising instructions that, when executed by at least one processor, cause a computing device to:
analyze a user-generated text block to determine a text block characteristic of the user-generated text block;
identify a survey question of an electronic survey based on determining that the text block characteristic of the user-generated text block relates to the survey question of the electronic survey; and
generate a survey response for the survey question based on content of the user-generated text block.

13. The non-transitory computer readable storage medium of claim 12, further comprising instructions that, when executed by the at least one processor, cause the computing device to:
associate the survey question with a text characteristic that corresponds to text useful to answering the survey question,
wherein the instructions, when executed by the at least one processor, cause the computing device to determine that the text block characteristic of the user-generated text block relates to the survey question by determining that the text block characteristic of the user-generated text block satisfies the text characteristic.

14. The non-transitory computer readable storage medium of claim 12, further comprising instructions that, when executed by the at least one processor, cause the computing device to access a text block database comprising a plurality of pre-existing user-generated text blocks that comprises the user-generated text block,
wherein the instructions, when executed by the at least one processor, cause the computing device to:
identify the survey question of the electronic survey by analyzing each of the plurality of pre-existing user-generated text blocks to determine text blocks that relate to the survey question; and
generate the survey response for the survey question by generating survey responses based on contents of each pre-existing user-generated text block from the text blocks determined to relate to the survey question.

15. The non-transitory computer readable storage medium of claim 12, wherein the instructions, when executed by the at least one processor, cause the computing device to generate the survey response for the survey question by using a machine learning model to generate the survey response based on the content of the user-generated text block.

16. The non-transitory computer readable storage medium of claim 12, further comprising instructions that, when executed by the at least one processor, cause the computing device to:
determine that the text block characteristic of the user-generated text block relates to a second survey question of the electronic survey; and
generate a second survey response for the second survey question based on the content of the user-generated text block.

17. A system comprising:
at least one processor; and
a non-transitory computer readable storage medium comprising instructions that, when executed by the at least one processor, cause the system to:
analyze a user-generated text block to determine a text block characteristic of the user-generated text block;
identify a survey question of an electronic survey based on determining that the text block characteristic of the user-generated text block relates to the survey question of the electronic survey; and
generate a survey response for the survey question based on content of the user-generated text block.

18. The system of claim 17, further comprising instructions that, when executed by the at least one processor, cause the system to:
associate the survey question with a text characteristic that corresponds to text useful to answering the survey question,
wherein the instructions, when executed by the at least one processor, cause the system to determine that the text block characteristic of the user-generated text block relates to the survey question by determining that the text block characteristic of the user-generated text block satisfies the text characteristic.

19. The system of claim 17, further comprising instructions that, when executed by the at least one processor, cause the system to access a text block database comprising a plurality of pre-existing user-generated text blocks that comprises the user-generated text block,
wherein the instructions, when executed by the at least one processor, cause the system to:
identify the survey question of the electronic survey by analyzing each of the plurality of pre-existing user-generated text blocks to determine text blocks that relate to the survey question; and
generate the survey response for the survey question by generating survey responses based on contents of each pre-existing user-generated text block from the text blocks determined to relate to the survey question.

20. The system of claim 17, wherein the instructions, when executed by the at least one processor, cause the system to generate the survey response for the survey question by using a machine learning model to generate the survey response based on the content of the user-generated text block.
